(19) United States
(12) Patent Application Publication
(10) Pub. No.: US 2013/0036031 A1
(43) Pub. Date: Feb. 7, 2013

(54) System for monitoring land use activities

(71) Applicant: Ryan Hutchinson, Thibodaux, LA (US)

(72) Inventor: Ryan Hutchinson, Thibodaux, LA (US)

(73) Assignee: South Central Planning and Development Commission

(21) Appl. No.: 13/136,497

(22) Filed: Aug. 2, 2011

(51) Int. Cl. G06Q 50/16; G06Q 40/00; G06Q 10/06

(52) U.S. Cl. 705/30; 705/315; 705/301

(57) ABSTRACT

A land use activities system for monitoring and management of properties and property modifications located within each one of a plurality of jurisdictions. The system has a central database for storing information about each property, the central database enabling each jurisdiction to retrieve, write and modify the information about objects within the jurisdiction and create a jurisdiction database. The information pertains to land use activities in conjunction with a particular geographic location of the selected jurisdictions are any of: permit application for, and review of land use modification, plan review and approval for land use modification, and requests for, and inspection of land use modification for compliance with ordinances and regulations within the selected jurisdictions, as well as address verification and address management of properties within the jurisdiction.

### BACKGROUND OF THE INVENTION

This invention relates to land use and more specifically to a system for monitoring land use activities by a governmental entity.

Typically, a municipality or other local governmental authority controls the land use within its jurisdictional borders. Among the tools for regulating the land use, the government issues a building permit, which is a written authorization to construct a building, addition, fence or other structure. Permits are granted after building plans have been reviewed and determined to meet the requirements of the building code and City Zoning Ordinance. The townships require that a property owner obtain a permit, when erecting, constructing, enlarging, altering, repairing, improving, removing, converting, moving or demolishing any building, storage sheds or fences. Conventionally a property owner or a contractor applies for a building permit before construction or remodeling is initiated. Every jurisdiction has its own set of rules for the permit application, although usually the application process requires that the property owner or contractor submit plans for the proposed construction or remodeling, engineering plans, water, electric and gas plans, and the like. The plans are submitted on paper, in multiple copies. The price of the permit will vary depending on type of building and the square footage, as well as the type of construction proposed for the site.

The municipality usually has one or more departments responsible for issuing the permits, for conducting inspections, and for code enforcement. The city employees spend many work hours reviewing the permit applications and performing the inspections. The property owners often feel overwhelmed when going through the permit application process, even when the proposed project is less complex than erecting a new structure on site. The amount of paperwork involved in a permit application frustrates the land owner, especially if the land owner is not thoroughly familiar with the building codes and zoning ordinances. Building contractors, even if they regularly deal with the permit application process sometimes find that their schedules are delayed because the submitted plans have not been reviewed on time.

In view of the above, there exists a need for simplifying the permit and inspection process. The present invention contemplates elimination of drawbacks associated with conventional methods and provision of a computer-based system for monitoring land use activities through a single web portal that can be set up by the municipality and used by the public.

### SUMMARY OF THE INVENTION

It is, therefore an object of the present invention is to provide a system and method for responding to customer inquiries related to land activities.

It is another object of the invention to provide and system and method for use by municipalities in monitoring land activities, such as issuing construction permits and the like.

These and other objects of the invention are achieved through a provision of an object monitoring and management system for managing objects located within each one of a plurality of jurisdictions. The objects relate to land properties within the jurisdictions. The system has a central database for storing information about each property, the central database enabling each jurisdiction to retrieve, write and modify the information about objects within the jurisdiction and create a jurisdiction database. The information also comprises land use activities in conjunction with a particular geographic location of said selected jurisdictions are any of: permit application for, and review of land use modification, plan review and approval for land use modification, and requests for, and inspection of land use modification for compliance with ordinances and regulations within the selected jurisdictions.

The system has an interface for permitting each jurisdiction to: create data access groups, such as property owners, contractors, and inspectors. The system allows each jurisdiction to register selected ones of a plurality of computer-operated units with each data access group and associate each data access group with a selected subset of the information about objects located within the jurisdiction, such that each computer-operated unit that is registered with a given data access group is enabled to access only the respective subset of the information associated with that data access group. Each computer-operated unit permits a user to at least create new records in the respective subset of the information for storing information about modifications to the properties in the jurisdiction database. The system issues a respective object-modification identifier for each object modification, the new object identifier being assigned to the corresponding new record and is unique across the central database; and connection means for synchronizing the respective jurisdiction database with the central database.

### BRIEF DESCRIPTION OF THE DRAWINGS

Reference will now be made to the drawings, wherein like parts are designated by like numerals, and wherein

FIG. 1 illustrates the system of the present invention operating through a designated portal and accessible by a governmental entity and the public.

FIG. 2 illustrates application of a module for conducting an advanced project search.

FIGS. 3-1 and 3-2 schematically illustrate application of a module for creating a project file.

FIG. 4 schematically illustrates application of a module for executing “upload permit file” function.

FIG. 5 schematically illustrates application of a module for executing a function “create contractor file.”

FIG. 6 schematically illustrates application of a module for executing contractor advanced search.

FIG. 7 schematically illustrates application of a module for executing a search of a list of scheduled projects.

FIG. 8 schematically illustrates application of a module for executing plan review search.

FIG. 9 schematically illustrates application of a module for executing plan review search according to permit number.

FIG. 10 schematically illustrates application of a module for executing inspection (work order) search.

FIG. 11 schematically illustrates application of a module for executing inspection (work order) search according to a permit number.

FIG. 12 schematically illustrates application of a module for executing locating inspectors function.

FIG. 13 schematically illustrates application of a module for executing a function of creating an inspection report.

FIG. 14 schematically illustrates application of a module for executing a function of generating a report and incorporating permit photos according to performed inspection.

FIG. 15 schematically illustrates application of a module for executing a function of scheduling and assigning a work order according to a geographic location.

FIG. 16 schematically illustrates application of a module for executing opening a code enforcement file (project).

FIG. 17 schematically illustrates application of a module for managing address request verification.

FIG. 18 schematically illustrates application of a module for creating a customer address request.

FIG. 19 schematically illustrates application of a module for opening an address verification case.

FIG. 20 schematically illustrates application of a module for editing street points report.

FIG. 21 schematically illustrates application of a module for “edit streets” function.

FIG. 22 schematically illustrates application of a module for street address search.

FIG. 23 schematically illustrates application of a module for executing contact management.

FIG. 24 schematically illustrates application of a module for administrative editing to create a new street address for entering into the system database.

FIG. 25 schematically illustrates application of a module for executing address request management.

FIG. 26 schematically illustrates application of a module for address search.

FIG. 27 schematically illustrates application of a module for creating a fee breakout report.

FIG. 28 schematically illustrates application of a module for creating a report of fees overages and underages.

FIG. 29 schematically illustrates application of a module for creating a report of fees collected by the jurisdiction for defined projects.

FIG. 30 schematically illustrates application of a module for creating an invoice to be sent to a customer.

FIG. 31 schematically illustrates application of a module for creating daily “funds-received” report.

FIG. 32 schematically illustrates application of a module for creating a report of fees breakout based on permit type.

FIG. 33 schematically illustrates application of a module for creating a monthly permits report.

FIG. 34 schematically illustrates application of a module for executing a random permit audit.

FIG. 35 schematically illustrates application of a module for creating a weekly permits report.

FIG. 36 schematically illustrates application of a module for executing an environmental management permit (EMP) report.

FIG. 37 schematically illustrates application of a module for creating EMP permit summary report based on the type of permit.

FIG. 38 schematically illustrates application of a module for creating a building permit summary report based on the council district.

FIG. 39 schematically illustrates application of a module for creating a building permit summary report based on the permit type.

FIG. 40 schematically illustrates application of a module for creating a fee breakdown report based on permit number.

FIG. 41 schematically illustrates application of a module for creating a permit summary report by permit category.

FIG. 42 schematically illustrates application of a module for creating a report based on customer permit requests.

FIG. 43 schematically illustrates an online page accessible by a customer through the jurisdiction/customer online portal.

FIG. 44 schematically illustrates application of a module for creating a permit application by a customer.

FIG. 45 schematically illustrates application of a module for managing permit applications by a customer.

FIG. 46 schematically illustrates application of a module for creating a new account by a customer.

FIG. 47 schematically illustrates application of a module of frequently asked questions on the jurisdiction/customer portal.

FIG. 48 schematically illustrates application of a module for linking the jurisdiction/customer portal to another web site.

FIG. 49 schematically illustrates application of a module for creating checklists, forms and guides for customer use.

### DETAIL DESCRIPTION OF THE INVENTION

The invention provides a computerized land use monitoring and management system that enables comprehensive jurisdictional tracking, maintenance and/or management of land use activities by the public. The system also permits owners of real estate to submit plans, request and obtain permits for land use, as well as schedule inspections of the projects under the permits. The system provides a unique, automated approach to assist municipalities and their public clients in organizing, planning, implementing and tracking land sue projects by providing a centralized automated and integrated series of solution to land use administrative requirements. In particular, the system of the instant invention centralizes, from a central database and portal, the planning stage of a real estate project, the application and issuance of permit for a land use project, including the necessary inspections and associated reporting. In this manner, the successful management of land use by municipality and the public is more assured as compared with prior art manual approaches.

The existing methodologies to obtain such pertinent data as zoning requirements for a specific plot of land are usually buried in cumbersome zoning ordinances or similar property related documents, such as covenants, conditions and restrictions. This invention removes the need to go through this time consuming process and allows the user to go through a process of plan submission and permit application as it relates to size, use, parking, signage, code summary and a specific property's information as well as various related municipal ordinances such as “green ordinances.”

The municipalities have control over land use within their jurisdiction. Permits for building construction, remodeling or expansion are not issued until all required inspections have been conducted and the construction is approved. The process for building inspections is also time-consuming because a city inspector conducts the inspection based on both the reviewed building plans and adopted city codes and ordinances. If the inspection fails, the customer is notified with a red tag or an inspection notice that lists the deficiencies that must be resolved. The customer must correct the non-compliant work and call for a re-inspection. The present invention expedites this process by allowing the customer to check for compliance with the city code before the inspection is scheduled. The invention also allows the city inspectors to inform the customers of any non-compliance via a shared portal, to which the jurisdiction (municipality) and the public have access.

The system maintains a central database for storing information about each object (property within the jurisdiction), the central database enabling each jurisdiction to retrieve, write and modify the information about objects within the jurisdiction and create a jurisdiction database. An interface permits each jurisdiction to: create data access groups; register selected ones of a plurality of computer-operated units with each data access group; and associate each data access group with a selected subset of the information about objects located within the jurisdiction, such that each computer-operated unit that is registered with a given data access group is enabled to access only the respective subset of the information associated with that data access group; wherein each computer-operated unit: permits a user to at least create new records in the respective subset of the information for storing information about modifications to the objects in the jurisdiction database; and issues a respective object-modification identifier for each object modification, the new object identifier being assigned to the corresponding new record and is unique across the central database; and connection means for synchronizing the respective jurisdiction database with the central database.

The central database is connected to an open network via a gateway that enables secure access to the central database by the jurisdiction and customers seeking permit for land use modification projects associated with each property. The connection means for synchronizing the subset of information with the central database comprises a link between the jurisdiction database and the open network for communication with the gateway, where the link includes a connection to a computer that comprises conduit software for interacting with the jurisdiction database and the central database using the open network, to synchronize the jurisdiction database with the central database by exchanging information between the jurisdiction database and the central database. In the preferred embodiment, the open network is the Internet. In one aspect of the invention, record of the central database comprises a respective timestamp that indicates when each record was last modified and what user performed the modification.

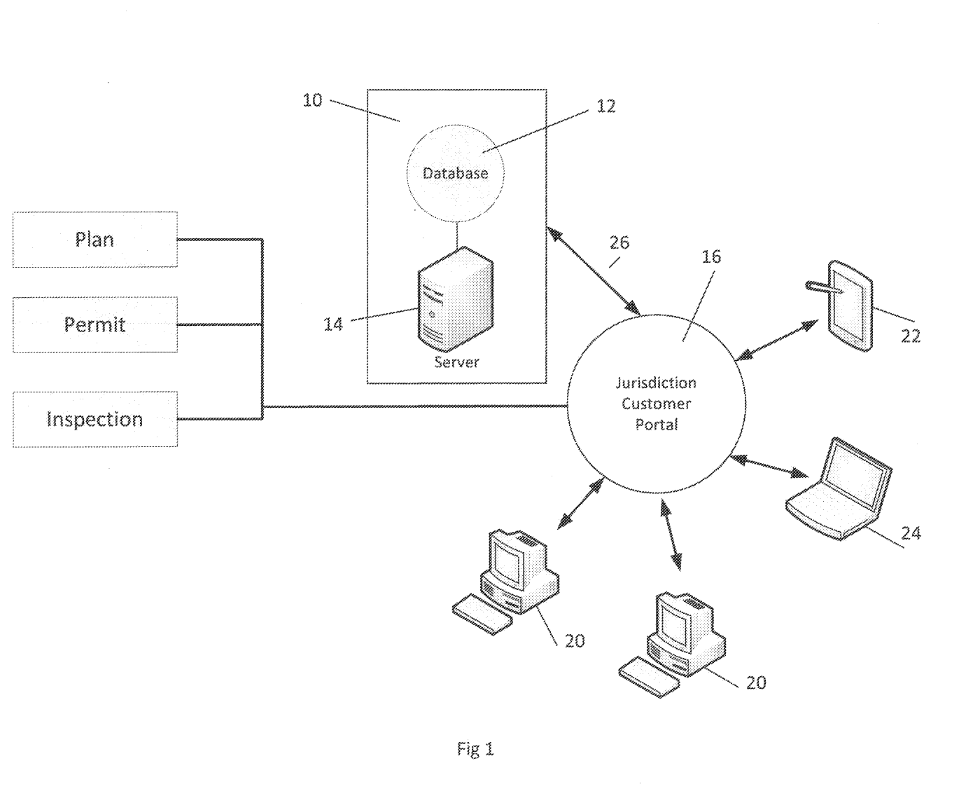

FIG. 1 schematically illustrates a conceptual diagram the land use system 10 in accordance with an embodiment of the invention. Globally accessible database 12 is configured to store information about monitored objects, such as parcels of land, structures, ordinances, zoning regulations, addresses, plats maps, land titles, and other information essential in regulating land use within a jurisdiction. Each monitored object is identified by a computer readable identifier unique for the particular jurisdiction. The database 12 is connected to a centralized server 14 accessed via a gateway or portal 16 that serves as a secure entry channel. Access to the database 12 is restricted by a security layer, such as a firewall and/or other access control systems.

A municipality and the general public access the database using communications devices such as desktop computers 20, handheld portable units 22, portable computers 24 and other devices capable of communicating via an open network, such as the Internet. The communication devices 20, 22, and 24 communicate with the server 14 through a bi-directional link 26. Each user is provided with a unique log-in identifier and password.

A municipality department in charge of reviewing plans, issuing permits, etc. is allowed to access numerous projects created by the customers, while a customer is allowed access only to a specified project relating to the customer's land use. The municipality can input certain criteria, procedures and policies, thus creating pre-set modules, with which the customer side of the system can interact. The jurisdiction part of the system is accessed by inputting the authorized user's log-in information and password. An authorized city employee, using a computer connected to the portal 16, can perform a search of all projects currently under consideration or archived. Conventionally, all projects are issued an identifier in the central database pertaining to any given project. The identifier can be numerical or alpha-numerical.

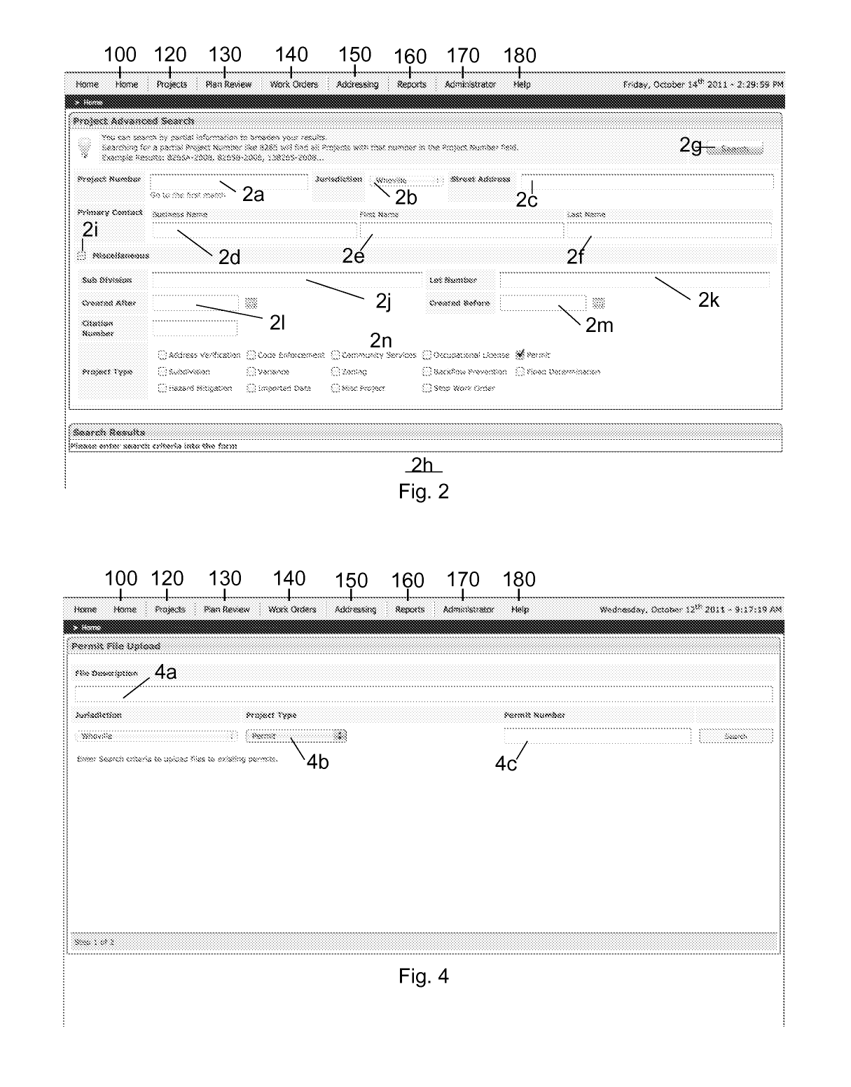

FIG. 2 schematically illustrates utilization of a “search” module that forms a part of the system of the present invention. The system generates a web page to assist the jurisdictional user in performing “Projects” search. The web page displays several headings: Home 100, Projects 120, Plan Review 130, Work Orders 140, Addressing 150, Reports 160, Administrator 170, and Help 180. When the jurisdictional user clicks on the heading 120 “Projects,” a submenu appears, which contains sub-headings “Search,” “Create,” “Upload,” “Contractors,” and “Department Queue.” By clicking on the “Search” sub-heading the jurisdictional user opens the page of similar to FIG. 2, where the user can filter the search criteria. Partially input information will produce the largest number of search hits.

The user can input a project number in box 2a, jurisdiction name in box 2b, the property street address in box 2c, the primary contact's business name in box 2d, or the primary contact's real name in boxes 2e and 2f. By clicking on the “Search” button 2g, the user sends a signal to the system to perform a database search based on the input criteria. Even partially input information will produce a match or several possible matches for the city employee to choose. If the municipality employee does not have information on the exact location of the project but knows the street name, the search function of the system of the present invention will allow the employee to search the multiple projects through the input of one or more criteria in the search box. The search results will be displayed in the field 2h.

Optionally, the jurisdictional user can input search criteria using the “Miscellaneous” path 2i. When the user clicks on the button 2i, a normally collapsed portion of the page opens displaying additional search entries that can be used. For instance, the user can input a subdivision name in box 2j, a lot number of the property in box 2k, the date limits in boxes 2l and 2m, or a project type (Address Verification, Backflow Prevention, Code Enforcement, Community Services, Hazard Mitigation, Imported Data, Miscellaneous Project, Occupational License, Permit, Subdivision, Variance, or Zoning) selected from a dropdown menu in box 2n. If the system database contains a citation associated with the property, the citation number can be input in box 2o and the cross-referencing feature of the system will retrieve the project to be displayed in the field 2h.

The system comprises a module allowing a city employee to create a project, for instance a construction permit, address verification, code enforcement, occupational license, subdivision variance, or zoning using a form schematically illustrated in FIGS. 3-1 and 3-2. The “project create” module is accessible from the “Create” subheading in the “Projects” heading 120. The system directs the computer to open an interactive page, which guides the city user through the process of inputting the necessary information, including the name of the jurisdiction in box 3a, project type (address Verification, Code Enforcement, Community Services, Occupational License, Permit, Subdivision, Variance, or Zoning) in box 3b. The system will generate the Project Number and display it in box 3c. This number is saved in the system for any future reference or cross-reference.

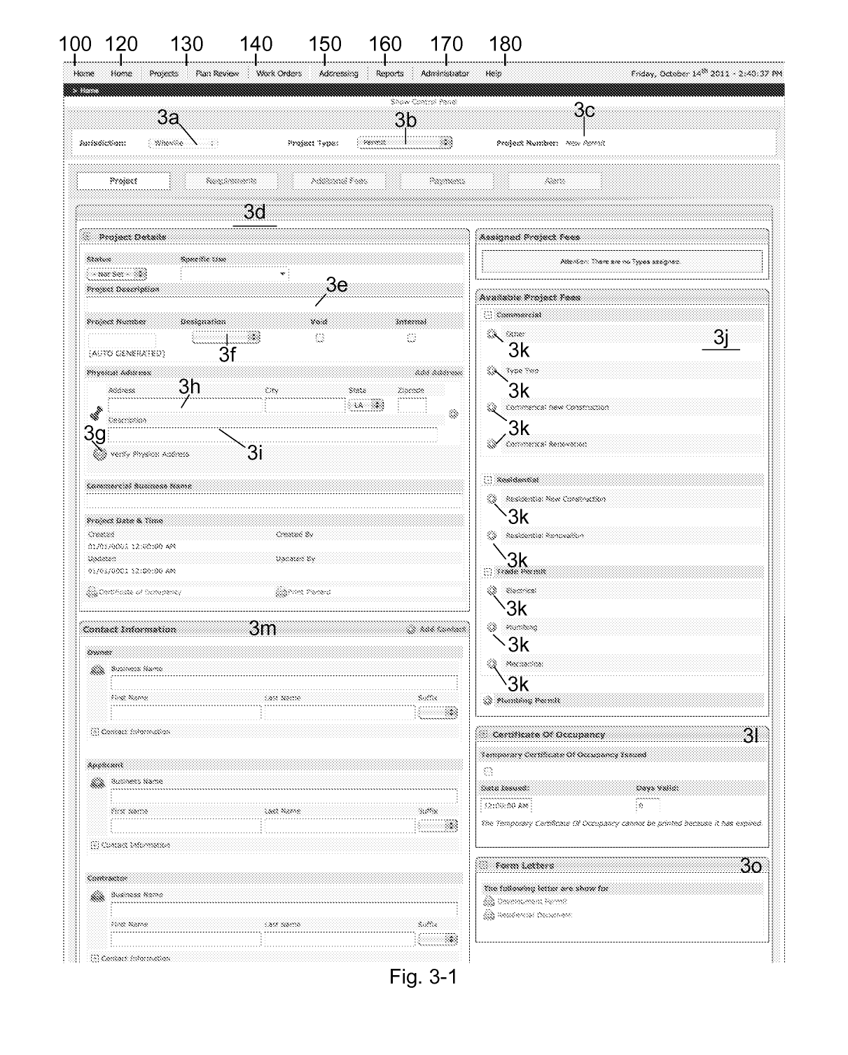

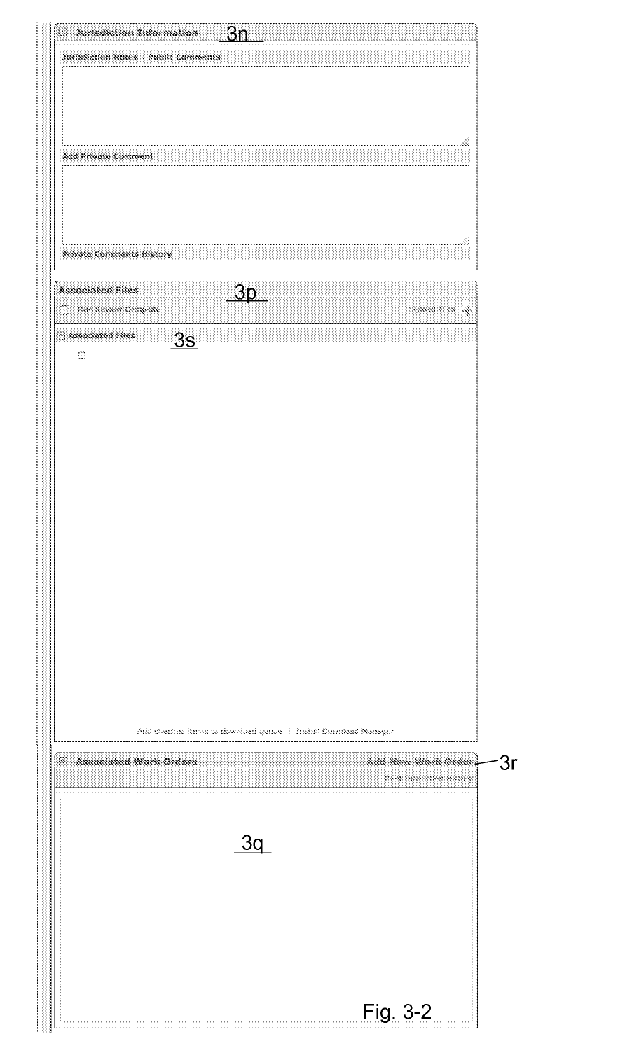

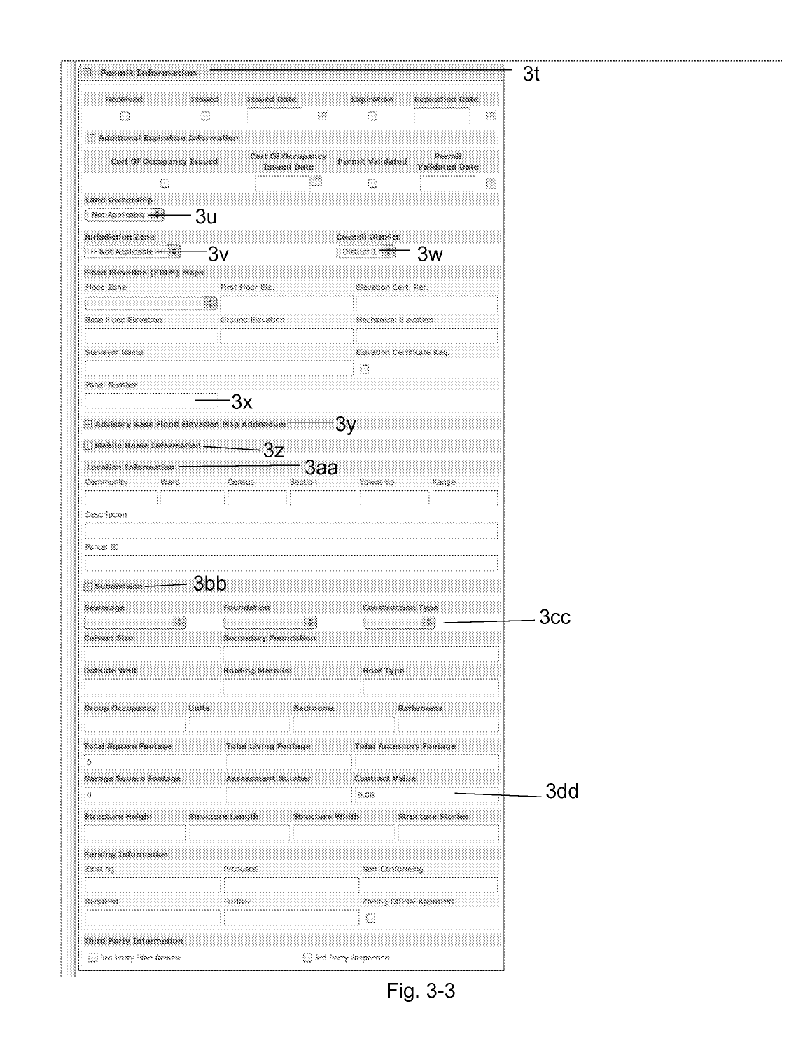

The Project Details are input in portion 3d of the page shown in FIG. 3-1. This portion of the page can be collapsed and expanded, if necessary. The project details contain such entries as “status” (“not set,” “approved,” “denied,” or “completed”), “Specific Use” (a single family house, a duplex, or a commercial construction), Project description in box 3e. Box 3f asks the city user to choose the designation of the permit, such as “residential,” “commercial” or “trade permit.” The Project Number is automatically generated.

The city user then is requested to add the address of the project that is a physical address with a street name and house number. One of the particular advantages of the system of the present invention is that it provides a means for verifying an address associated with a particular project within the jurisdiction. Conventionally, a municipality has a special department which assigns street addresses to structures within its jurisdiction, which are then approved by a city ordinance. Sometimes, the addresses are either improperly entered into the records or map cross-referencing results in an error. The city user can click on a button 3g “Verify Physical Address” from the main “project details” window of FIG. 3-1 and enter the address as submitted with a permit application.

The system “Address Verification” module accessible from the “Projects” heading 120 verifies if the submitted address is recognized by the addressing authority of the selected jurisdiction. Even if the address is recognized, it does not necessarily mean that the address authority recognizes the inputted address as a valid address for the physical location of the project. To verify that this address is assigned to a particular physical location, the user is directed to submit the Address Verification request. The user can input the known address in boxes 3h, description of the property in box 3i. Additionally, the user may upload a map of the property, if available and list the number assigned to the real property by the tax assessor's office. The user can then insert the contact information, including telephone numbers, email addresses, and names of the property owner or tenant. Once the user introduces all required information, the user can submit the address verification address, which will be checked against the records stored in the database 12.

The interactive page shown schematically in FIG. 3-1 provides a means for listing project fees associated with the project. Box 3j gives the user a list of Available Project Fees: commercial (Commercial Construction, Commercial Renovation, or Type Two), residential (new construction or renovation), Trade Permit (electrical, plumbing, or mechanical) or Plumbing Permit. When the user clicks on a “plus” button 3k in the left-hand column, the system expands the box guiding the user to enter qualifying data, such as square footage, contract value, or any other amount that allows the system to display, on the computer monitor, the amount of assigned project fees. Depending on the type of project envisioned by the customer, the assigned fees will differ. The user can select any of the “plus buttons” and follow the same steps for any type of project, for which a permit file can be created.

The system software requests the user to indicate whether a Temporary Certificate of Occupancy has been issued, the date of issuance and the number of days the Certificate is valid in box 3l. Box 3m is designed for entry of the contact information associated with the particular project, be it the property owner, an applicant, or a contractor.

Box 3n provides a means to enter the jurisdiction notes, including public comments and private comments. Box 3o provides a means to generate form letters directed to the contact person, such as “Development permit’ or “Residential Document.” Of course, various other form letters can be uploaded and stored in the system database for sue by the jurisdictional user.

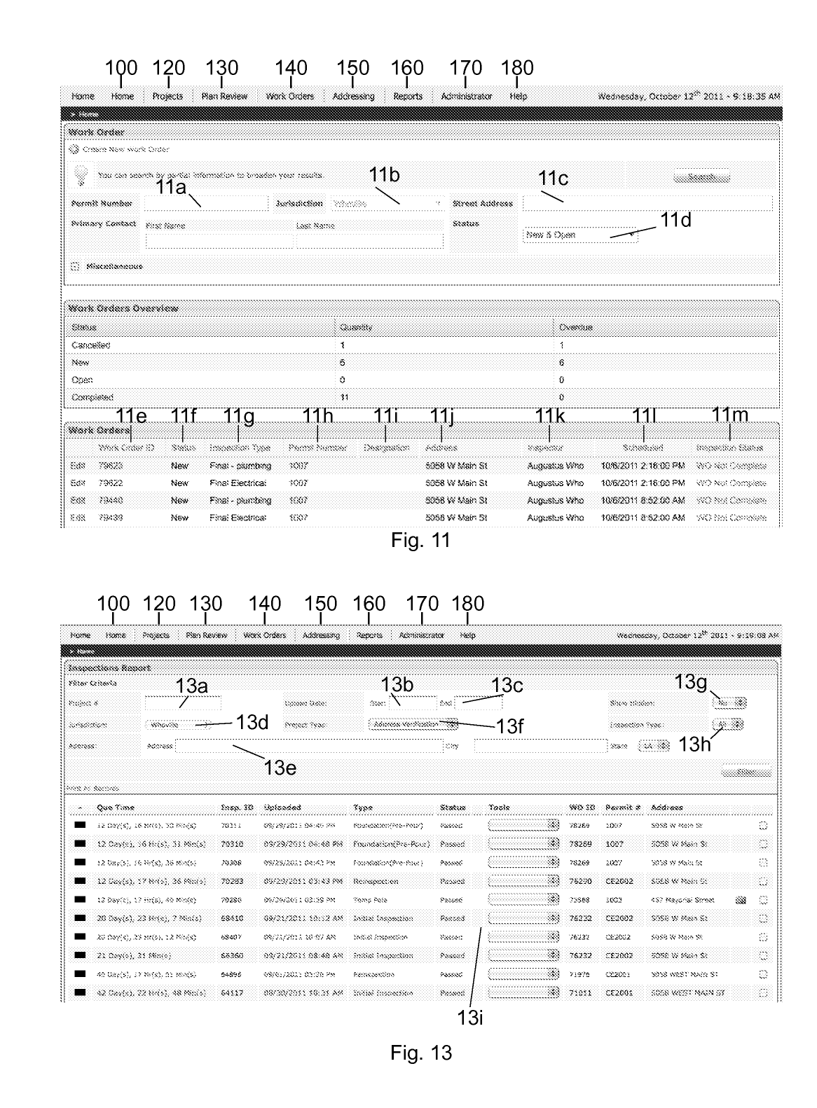

Turning now to FIG. 3-2, the second portion of the interactive page of “create project” tool illustrates additional steps that the jurisdictional user can take to create a file on the specific project. For cross-referencing purposes, box 3p serves as a means for uploading any files associated with the projects, such as plan review files, drawings, permit requests and the like. Box 3q provides a means for adding work orders associated with the project. By clicking on a button 3r “Add new Work Order” the user will be redirected to another page, which is schematically illustrated in FIG. 11, and which will be described in more detail hereinafter. Any associated files can be listed under a portion 3s “Associated Files.”

The system provides a means for entering detailed “Permit Information” in box 3t. The relevant information can include such entries as permit receive, issued, the issue and expiration dates, cost of occupancy issued, whether permit was validated and validation date. A dropdown menu in box 3u gives a selection for “land ownership” (owned, rented, family, family estate, trailer park). Jurisdiction zone and council district are entered in boxes 3v and 3w, respectively.

Flood zone data is entered in the portion of the page entitled “Flood Elevation (FIRM) Maps”, where the user introduces data about the flood zone, first floor elevation, base flood elevation, ground elevation, mechanical elevation and whether elevation certificate is required. For a municipality in a flood-prone area, the system guides the user through introducing data on flood elevation according to the Flood Insurance Rate Maps (FIRMs) created by Federal emergency Management Agency (FEMA). Private citizens, insurance and brokers use the FIRM to locate properties and buildings to determine the amount of flood risk and whether flood insurance is required. Community officials use the FIRM to administer floodplain management regulations and to mitigate flood damage. Lending institutions and federal agencies use the FIRM to locate properties and buildings in relation to mapped flood hazards, and to determine whether flood insurance is required when making loans or providing grants following a disaster for the purchase or construction of a building.

The flood zone alphanumeric symbols are available in a drop-down menu for the user's selection. The user is directed to data on first floor elevation, elevation certificate reference, base flood elevation, ground elevation and mechanical elevation. If the elevation certificate is required the city user can check the appropriate box on the page and the system will add this requirement to the list of requirements presented to the owner or contractor. If available, the city user can also enter the surveyor's name and panel number.

The surveyor name is listed in box 3x. Similar information can be entered in a collapsible box 3y entitled “Advisory Base Floor Elevation Map Addendum.”

If the project concerns a mobile trailer permit, the user enters the necessary information in box 3z “Mobile Home Information.” The relevant information may include trailer size, make and model, serial number; cost, the date the mobile home was purchased and the like. Box 3aa contains a collapsible table, where the user can enter “Location Information” for instance the name of the community, ward number, census, township, description of the location and other identifying information. A collapsible portion 3bb entitled “Subdivision” provides a means for identifying the project according to the subdivision name, tract, block number, lot number, lot size, valuation of the lot, etc. Information on growth area, lots to be created, location of the proposed subdivision and re-subdivision can also be listed in box 3bb.

Another portion of the interactive page shown in FIG. 3-2 provides a means of identifying the structure, which is the subject of the project. In this portion, the user lists the type of sewage on the property (municipal or septic tank), foundation (cement block, concrete slab, footing, piling or subsurface piling), construction type (metal or wood frame), type of roofing material, culvert size, roof type can be incorporated in the project file. The building size, type of siding, roofing material, number of bedrooms, stories and the like are listed in the portion 3cc of this page. The contract value of the project, on which the permit fee is based, is entered in box 3dd. The utilities information (gas, electric and water meter numbers, meter releases, etc.) is entered in the collapsible box 3ee.

The jurisdiction can also upload the file created based on an application by the member of the public. The “Upload” application is accessible from the heading 120 “Projects.” As schematically illustrated in FIG. 4, the jurisdiction authorized user enters a file description in box 4a, identifies the jurisdiction and the project type by selecting from a drop-down menu of box 4b “code enforcement,” or “permit,” or “address verification,” or “variance.” If the file was created earlier, the authorized user can search for the correct files stored in the jurisdiction database by permit number from box 4c and search any associated files, where additional information should be uploaded. The search results are displayed in the box 4e. The user can then upload additional data to the existing files.

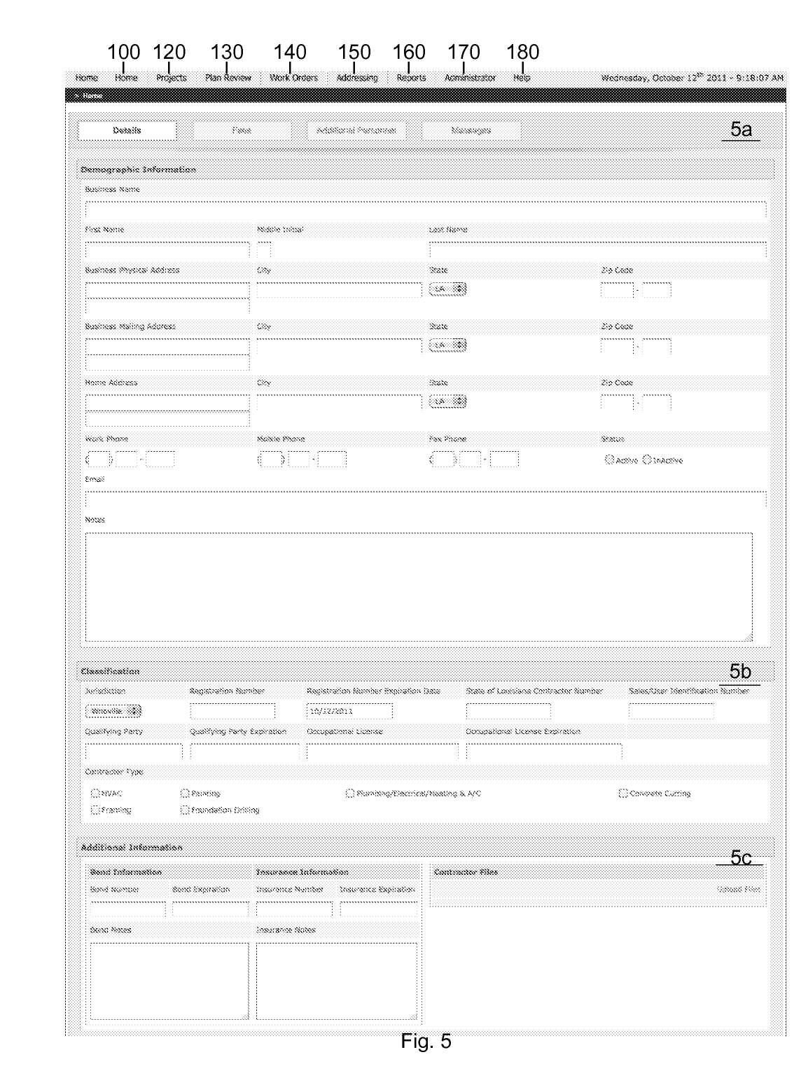

The system further comprises a module allowing a jurisdiction user to create a file for a contractor and store it in the system database 12. The names of licensed contractors can then be accessed by the public. As schematically shown in FIG. 5, the authorized user enters the contractor's name, home address, business address, telephone numbers and email in the portion of the page identified a 5a. The authorized user can also enter the license number of the contractor, license expiration date, state contractor number, state identification number and the type of license the contractor holds (such as HVAC, framing, painting, foundation drilling, plumbing/electrical/heating and air conditioning, or concrete cutting) in the portion 5b of the interactive page shown in FIG. 5.

Portion 5b of the page provides a means for entering additional information such as the qualifying party under the license, occupational license and its expiration date. Importantly, the contractor's insurance information is made available to the public through accessing the Portal 12. Any bond information or insurance information is entered in the portion 5c of the page and then stored in the system database.

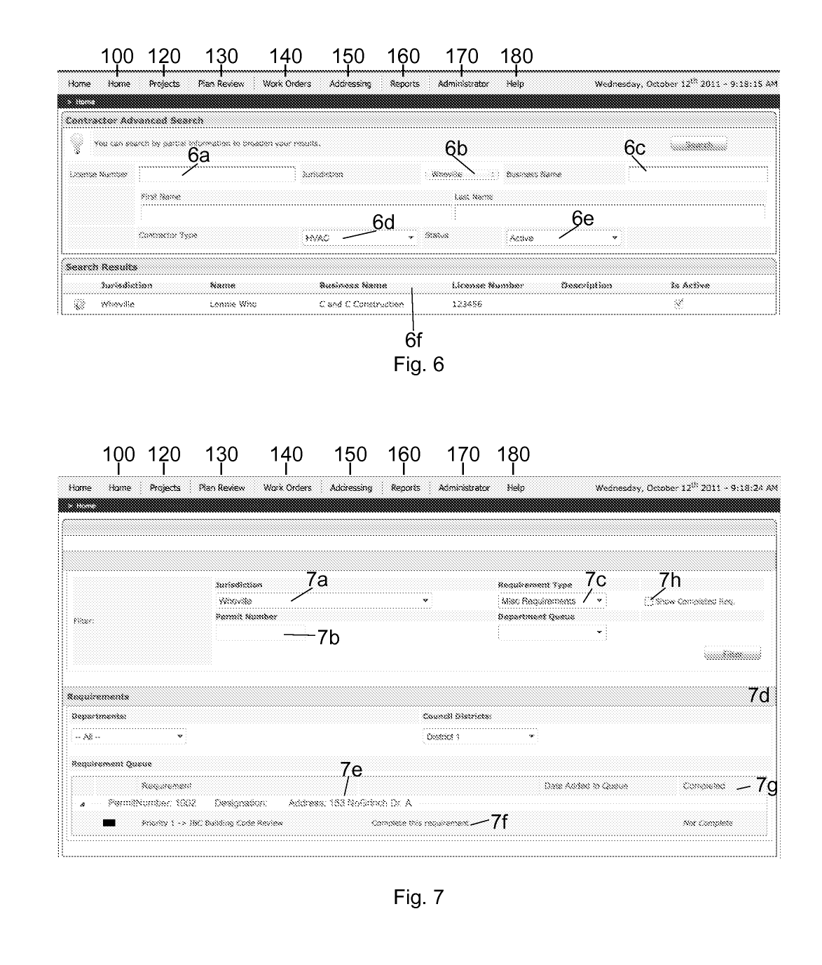

FIG. 6 schematically illustrates a module for executing steps of searching licensed contractors. This page can be accessed from the heading 120 “Projects,” subheading “Contractors Search.” The jurisdictional user can perform the advanced search by either entering the license number in box 6a, or jurisdiction in box 6b, or business name of the contractor in box 6c, or the contractor's personal name, or by selecting the contractor type (HVAC, gas, painting, plumbing, concrete framing, etc.) from the dropdown menu in box 6d. The status of the contractor (Active or inactive) can be selected from a dropdown menu 6e. The search request, even with partial information, will produce hits that are displayed on the computer screen in box 6f. There, the search results can be sorted by jurisdiction, contractor's name, business name, license number, description or active/inactive status.

The public and the jurisdiction authorized users can then perform a search through the contractors' database. As schematically shown in FIG. 6, the search can be made using either the license number, contractor's name, business name, or contractor type (HVAC, plumbing, framing, etc.). The same page opening for the user's view will show the status of the contractor's license (active or inactive).

The system of the present invention comprises a module allowing a jurisdictional user to search a list of scheduled projects. By selecting “Department Queue” from the heading 120 “Projects” the user accesses a page schematically shown in FIG. 7. The authorized user can quickly access information about the requirements that have not been yet met in the permit obtaining process. In the exemplary embodiment shown in FIG. 7, the user can filter the search by entering the jurisdiction name in box 7a, permit number in box 7b, or the requirement type in box 7c. The search results will be displayed in box 7d. The Requirement Queue is displayed in box 7e according to permit number. The type of requirement (such as building code review, construction drawings submittal, etc.) are listed next to the address of the property in line 7f. Non-completed requirements are shown in the “Completed” column 7g as “not complete.” If all requirements have been completed the jurisdiction authorized user can also filter the criteria by placing a check mark in the box 7h “Show Completed Requirements,” in which case the system search results will also display the completed requirements.

FIG. 8 schematically illustrates the use of a “Plan review search” module of this system accessible from the heading 130 “Plan Review.” The “plan review search” module allows the user to download and view the files from the main database as well as to upload any new “revised” files. The jurisdictional user is asked to enter the permit number, street address, and select the category of the plan review, whether residential or commercial. The user can also choose, as a search criteria, the status of the project, selecting between “new,” “in progress,” “client,” “completed,” and “third party.” The drop down menu under the “status” box allows the user to select any of these options.

The jurisdictional user also has an opportunity to upload the start date for the projects, which is assisted by a calendar selection icon 8a “upload start date” box. Similarly, the user can enter the upload end date by taking advantage of the interactive calendar icon 8b next to the “upload” and “date” box.

Once the necessary data has been introduced into the search criteria, the system retrieves the files based on the permit number, street address, or the primary contact number, depending on the information available to the jurisdictional user. Then the system software retrieves one or more plan review files in the “plan review” section of the page shown in FIG. 8. In the exemplary illustration of FIG. 8, the plan review is identified as “permit number 1001” under file name “Placard.” If the user clicks on the respective link for the permit identified in the plan review, the user will be taken to the page schematically shown in FIG. 3 from where the user can identify all necessary information with regards to the requirements still to be met by the contractor or property owner.

The “plan review” portion of this step also allows the user to upload revisions for the permit by clicking on the icon identified as 8c in FIG. 8, or review notes for the particular project by clicking on the button identified as 8d in FIG. 8 or add a permit message that clicking on an icon identified as 8e on FIG. 8. Alternatively, the jurisdictional user can initiate or respond to a chat request for immediate contact with the customer by clicking on an icon identified by numeral 8f in FIG. 8.

The system of this invention allows the user to store, upload, share and retrieve the files in any desired format. In this example, the file is shown in .pdf format. By clinking on the file, as in 8g in FIG. 8, the jurisdictional user is directed to a plan of the building and/or renovation that is the subject of the file existing in the system database. The plan drawings reflect the requirements for the particular project, such as reference to the code sections, ordinances and the like. The displayed file can be sent via the Internet to another authorized user, be it a jurisdictional user, a contractor, or the property owner. If the system does not contain an approved plan, the user will be unable to retrieve any specific file but instead will be advised that no file exists.

The jurisdictional user can also select the category of the project, be it residential or commercial, by clicking on the button 8h in FIG. 8. If the project has any revisions to the file, they will be reflected in the revision number shown schematically at 8i. If the jurisdictional user uploads any revisions, they will be shown by the existing files with a date stamp. In the exemplary embodiment shown in FIG. 8, the upload date is identified as Mar. 30, 2011 2:42:55 p.m.

FIG. 9 schematically illustrates the use of another module of the system for researching the plan review records based on the permit number, street address, or the primary contact number of the property owner and/or contractor. This module is accessible from the heading 130 “Plan Review.” The user has a choice of filtering the records by clicking on the button 9a, by instructing the system to either ignore hidden records or include hidden records by clicking on button 9b and by selecting revision start date, by clicking on the button 9c and/or the revision end date by clicking on the button 9d. In the example shown in FIG. 9, no records were found for display under the file name heading. However, if there were some revisions, they would be shown with “revision dates,” identify the revising entity as in “revision by, and/or revision number under the heading “revision” in line 9e.

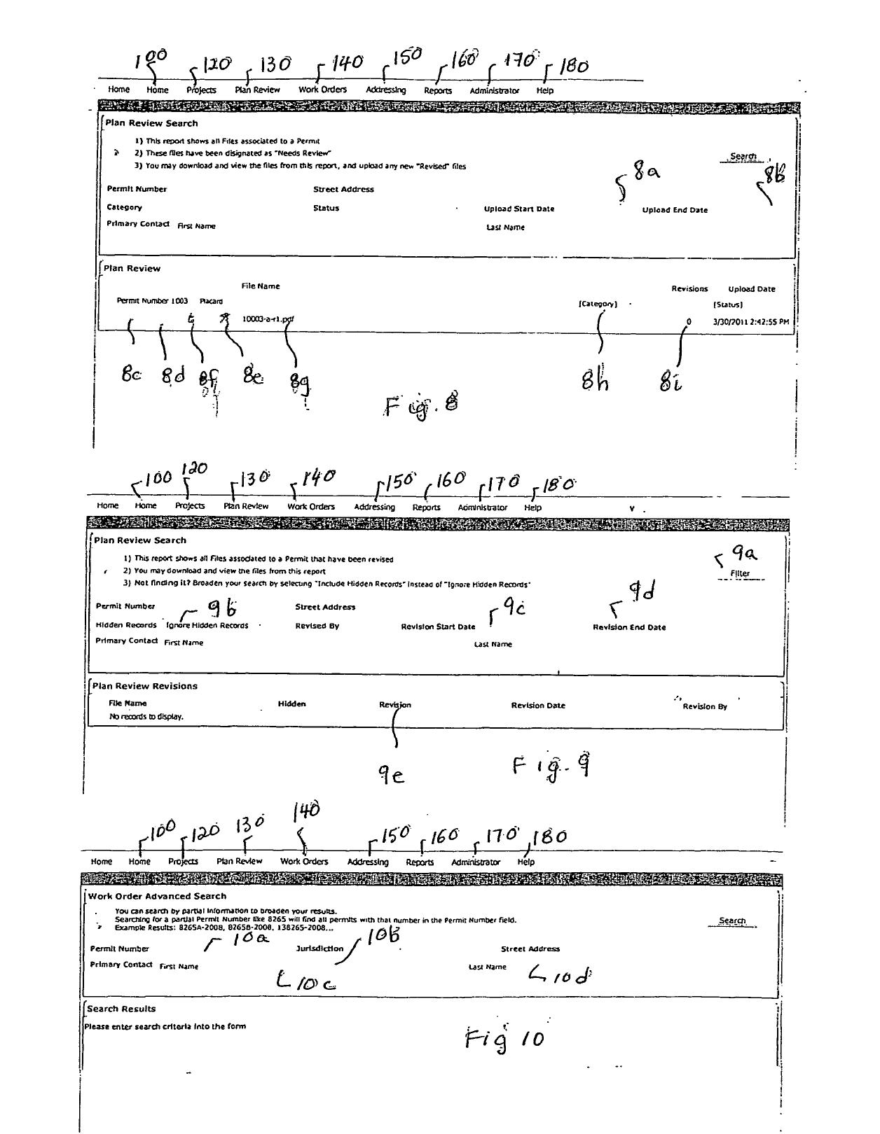

The system of the present invention has a module to allow the jurisdictional user to perform a search on “work orders” based on inspections, requests, and other criteria. By selecting the heading 140 “Work Orders” located on the tool bar of the on-screen presentation, as schematically shown in FIG. 10, and then selecting “create work order,” the user opens a page allowing the user to conduct a work order search based on partial or specific information. For instance, a permit number can be entered in box 10a, the jurisdiction name, be it a town, city or other entity, can be selected by the user by entering requesting info in box 10b. Alternatively, the user can enter the street address of the property where the work orders are to be performed and/or the first and last name of the primary contact by entering the requested information in boxes 10c and 10d, respectively. By clicking on the search button, the user sends a search request allowing the system software to conduct the search within the database of that particular jurisdiction.

The step of “All Review” under the “Work Orders” heading 140 opens another page on the jurisdictional website, such as the page schematically illustrated in FIG. 11. There, the jurisdictional user can create a new work order by either entering a permit number in line 11a, jurisdiction in box 11b, or street address in box 11c. The search can also be conducted based on the primary contact's name. In the “status” box 11d, a drop down menu is displayed allowing the user to select from either “new and opened,” “cancelled,” “new,” “open,” “completed” or “all”. The user can enter only partial information to broaden the search result and to extract more search hits from the database. In the exemplary illustration of FIG. 11, the “work order overview” shows in the “status” box, the type of work order (whether it is cancelled, new, open or completed). In the illustrated example, the system shows five completed work orders.

One or more optional steps allow the user to determine the work order I.D. by clicking on the line 11e, or status of the work order by clicking on the status button 11f, or the type of inspection, by clicking button 11g, or permit number, by clicking on the button 11h. Other information can be retrieved, as well, such as “designation” (11i), address (11j), name of the inspector (11k), whether the work order is scheduled (11l), or inspection status (11m) by clicking on the respective buttons.

A step of locating inspectors can be performed by clicking on the appropriate line in the dropdown menu from the “Work Orders” heading 140. In the exemplary schematic view of FIG. 12, a map of the local area, in this case Southern United States is displayed, and by clicking on the box 12a “Inspector,” the user can select from a list of authorized inspectors working in that particular jurisdiction. The interactive map can be enlarged to more precisely point out the location of the project for which the inspector's name can be drawn. By clicking on the button 12b “Plot,” the user can associate the inspector's location with a particular jurisdiction in question.

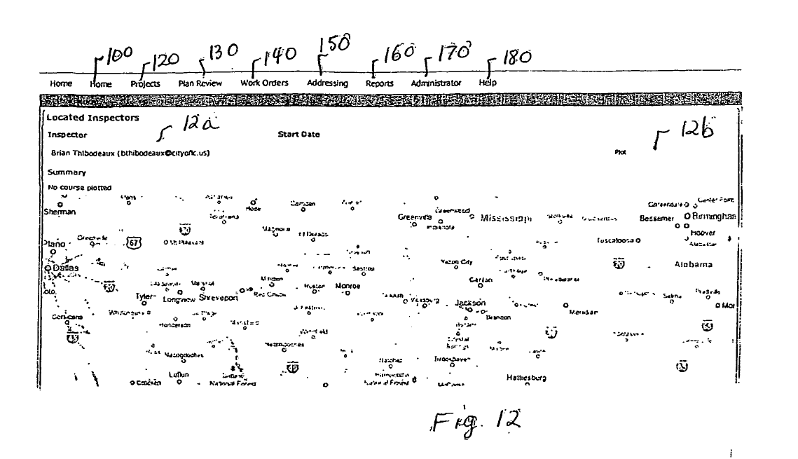

A step of searching completed inspection reports can be accessed by clicking on the “Work Orders’ heading 140 and allowing the system to display a page schematically illustrated in FIG. 13. The inspection report can be searched by such criteria as project number entered into box 13a, “upload’ start and end dates in the respective boxes 13b and 13c, by selecting a jurisdiction in box 13d, as well as by the address of the property (box 13e). The user can also select the type of project by making a selection from a dropdown menu of the box 13f in FIG. 13. The selection can be an address verification, code enforcement, permits, or variance. Additional criteria can be selected by showing hidden or non-hidden records from the choice in box 13g and the inspection type in box 13h. The lower portion of the screen, in the example shown in FIG. 13, shows the Queue time, inspection ID, type of inspection, status of inspection work order ID, permit number and address under the respective headings. The “tools” choice allows the user to select the type of action needed, for instance, “request power” by entering the choice in box 13i.

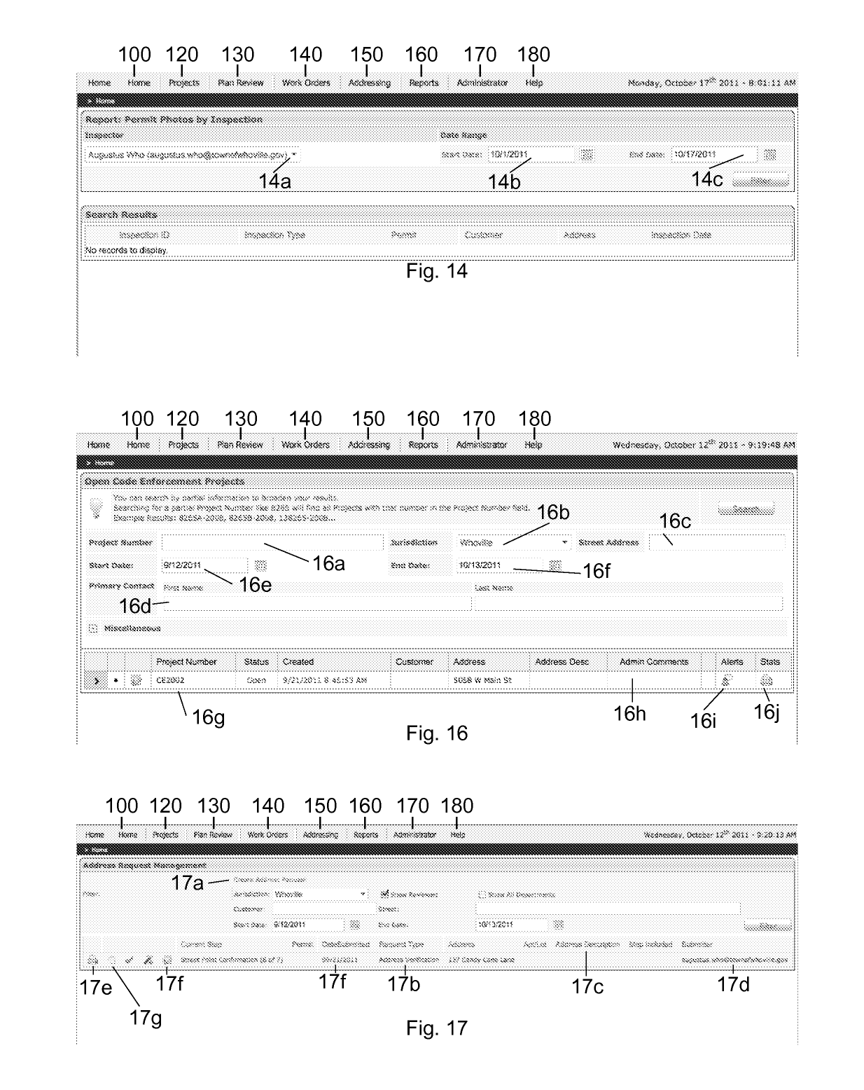

FIG. 14 illustrates a step of “Inspector Folder Upload” accessible from the “Work Orders” heading 140, wherein the inspector can upload the status of the project under the inspector's name in box 14a and start and end date in boxes 14b and 14c, respectively. In this example, results show a certain inspector, Augustus, and date ranges between May 31, 2011 and Jun. 1, 2011. Of course, the user can introduce any desired date.

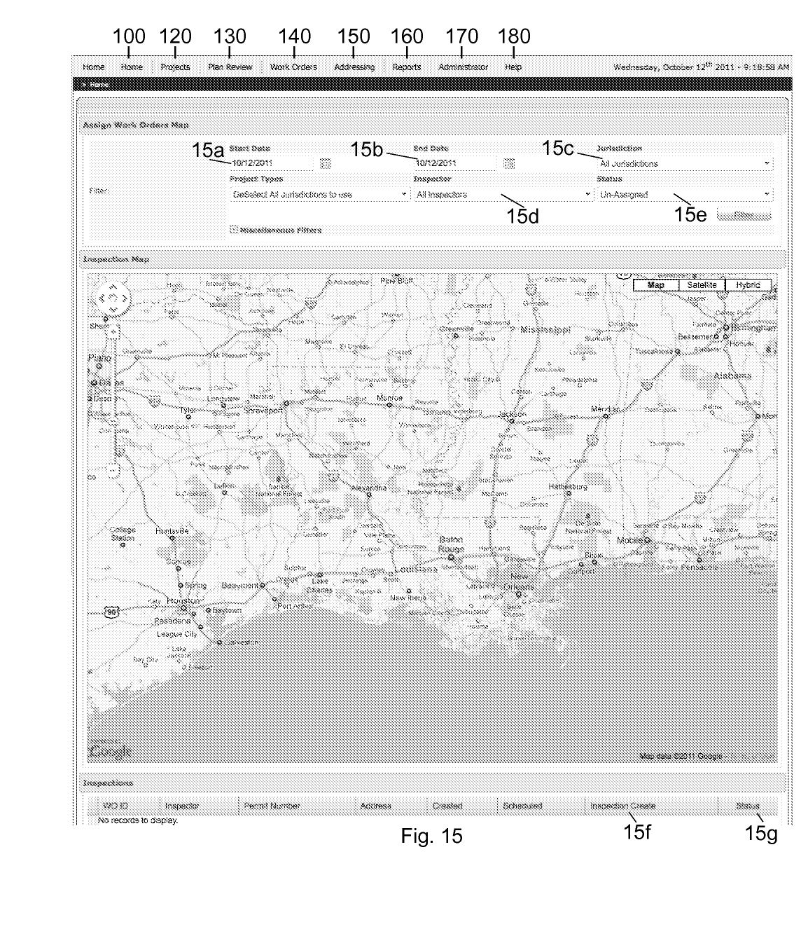

A step of “Work Order Maps” can be chosen from the “Work Orders” heading 140. The user can assign the work orders map and filter the data by entering the start date in box 15a of FIG. 15, end date in box 15b, jurisdiction in box 15c, and other inspector's name in box 15d. The lower part of the screen will show the inspections by work order I.D., by an inspector, permit number, address, the date created, the date scheduled, or by the type of inspection created by in the respective boxes in line 15f. The status of the assigned work orders will be displayed in the “status” column 15g in FIG. 15.

A step of managing complaints from the public can be accessed by selecting this choice from the drop-down menu under the heading 140 “Work Orders.” The jurisdictional user can either create or view code enforcement projects initiated by the governmental entity. As schematically illustrated in FIG. 16, the user can search the “complaints” database by entering the project number in box 16a, jurisdiction in box 16b, street address in box 16c, or by the primary contact's name in box 16d. Alternatively, the start and end dates can be sued as filtering search criteria (boxes 16e and 16f).

The retrieved search results are displayed in the lower part of the screen according to the project number, status, the date created, customer's name, address, or address description in line 16g. If the administrator had any comments they can be displayed in box 16h, and alerts—in box 16i. The statistics will be displayed in box 16j.

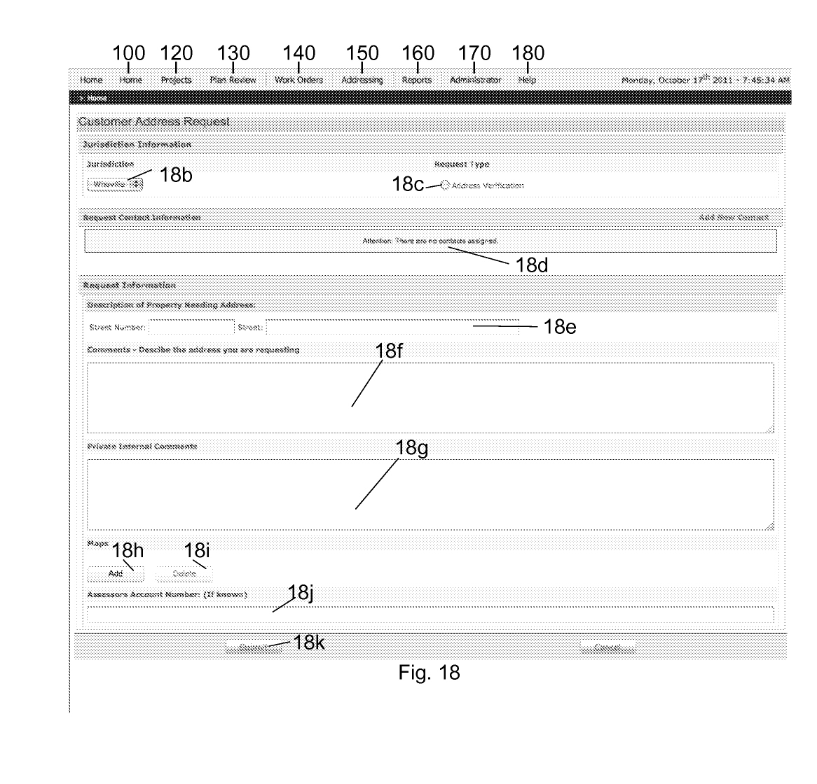

One of the advantageous features of the present invention is the ability for the user to verify the address based on partial information input by a user in the search criteria. The toolbar contains the “Addressing” heading 150 which brings the user to a dropdown menu containing such entries as “address request,” “edit street,” “edit streets.” The jurisdictional administrator can create new street, create address request, address messages and create an error report. When the user chooses “address request,” the user is directed to a page schematically illustrated in FIG. 17. The user can filter the requested task by clicking a button 17a “Create Address Request” and be directed to a page schematically illustrated in FIG. 18. The customer selects a jurisdiction from a dropdown menu in box 18b and clicks on the button 18c “Address Verification,” while the system will highlight a box 18d, which requires the customer to introduce contact information. The customer then enters a description of the property for which address verification is requested by entering the street number in Box 18e, with an option to describe the property in box 18f. Private internal comments can be entered in box 18g. If the customer desires to add a map of the property, the customer will click on a button 18h. From there, the customer will be allowed to select a map from the customer's computer database and upload the map into the database 12. If a mistake was made, the customer will be allowed to delete the uploaded map by clicking on box 18i. The filtering of the information can also be accompanied by introducing a property assessor's account number in Box 18j.

Once all the requested information is introduced, the customer can click on the “submit” button 18k and be redirected to the page schematically illustrated in FIG. 17. The system will automatically fill in the customer address request in the “address request management” page and will show the “date submitted,” the “request type” in lines 17b, as well as the description of the property in line 17c of FIG. 17. If the map was included in the uploaded information, the system will show that such information exists in line 17d.

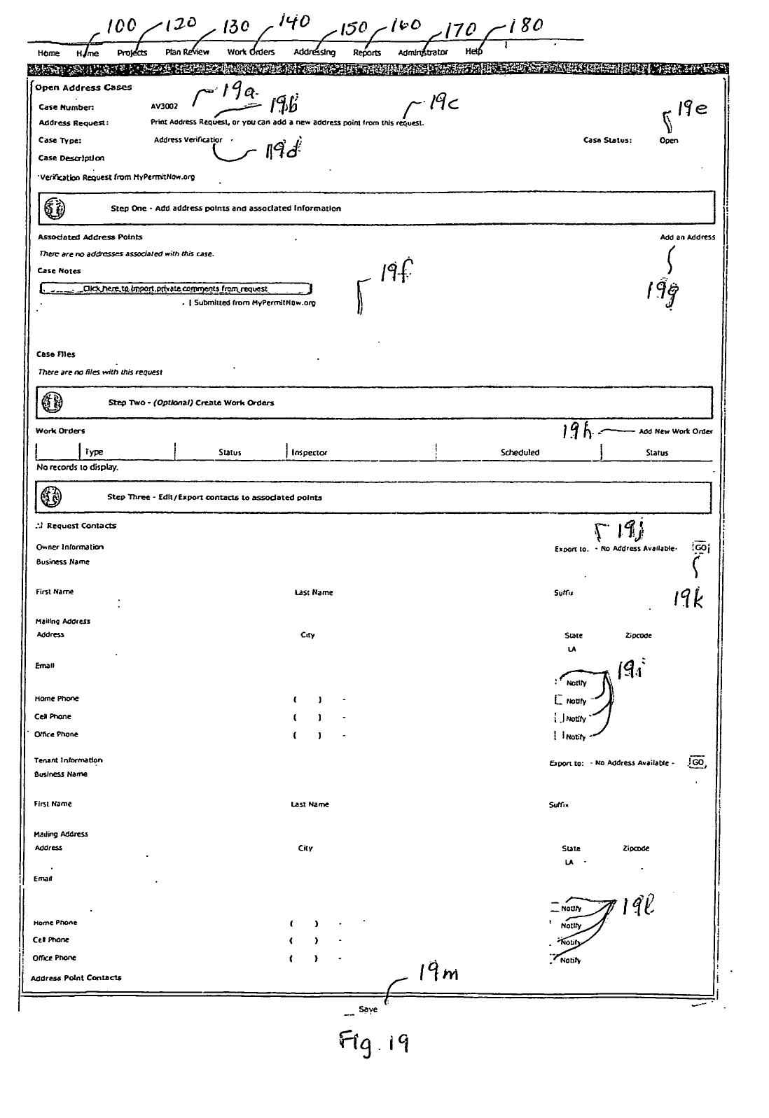

The customer is presented with several options in the “address request management” page. One of the options is to print the request by clicking on an icon 17e, or to copy the information by clicking on an icon 17f or, by clicking on an icon 17g to “open a new address” case. If the customer clicks on the icon 17g for opening a new address case, the customer is directed to a page schematically illustrated in FIG. 19. The system automatically issues a case number in box 19a and the customer is given an option of either printing an address request by clicking on line 19b or adding a new address point by clicking on line 19c. The “case status” is shown in Box 19e as either “open” or “closed.” The case type, in this illustration “Address Verification,” is shown in line 19d.

The customer is guided through several steps in the optional step of “opening a new address case.” One of the first steps is to confirm that the address shown in box 19f is the correct address for opening the case file. If necessary, the customer is allowed to enter a new address by clicking a “add an address” in box 19g. In the next step the customer has an opportunity to add or verify work orders associated with the address file. The customer can view whether work orders have been assigned to this address, the status, the name of the inspector assigned to the case, any scheduled work orders and status thereof. If necessary, the customer is allowed to add a new work order by filling in the requested information in line 19h.

In step three, the customer is guided to edit/export contacts associated with the opening of the address case. In this step, the customer is requested to enter the “order information” using the business name or physical name of a person, the mailing address, telephone. numbers, and clicking in boxes 19i, as to which mode of notification the customer prefers. If the customer requires that the contact be exported to a certain entity, the customer enters that information in Box 19j. By clicking on the “Go” button 19k, the customer sends the request to the system. If the property is rented and the customer wants the tenant to be the contact person, the customer enters information in the tenant section of the page. There, the name, address, telephone numbers, and emails of the tenant are introduced with the customer being allowed to choose the preferred method of notification by clicking on box 191, as shown on FIG. 19. The information can be saved in the database 12 by clicking on the “save” button 19m.

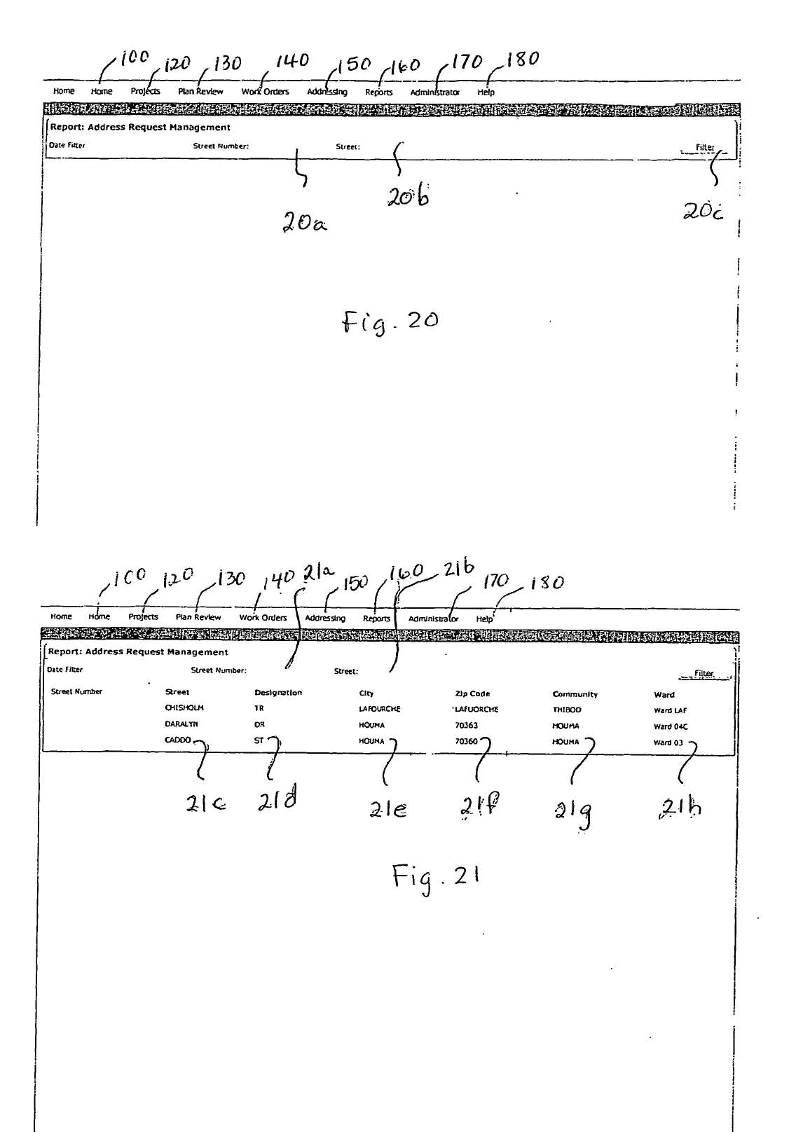

If the customer chooses the step of “Edit Street Points” from the “Addressing” heading the customer is directed to a page schematically illustrated in FIG. 20. There, system applies a module allowing the customer can filter the request by entering the physical number of street name in boxes 20a and 20b. By clicking on the filter button, 20c, the customer directs the system to bring up a filtering page schematically illustrated in FIG. 21. There, the customer can enter street number and street addresses in boxes 21a and 21b, and the street name will be displayed in line 21c in column “street”. The system also verifies the street designation and displays it in column 21d (street, drive, trail, highway, etc.) The city name is displayed in column 21e and the zip code for the case selected by the user for address verification is displayed in column 21f. The community (a township or a district within a city) is displayed in column 21g, while the ward number information is displayed in column 21h.

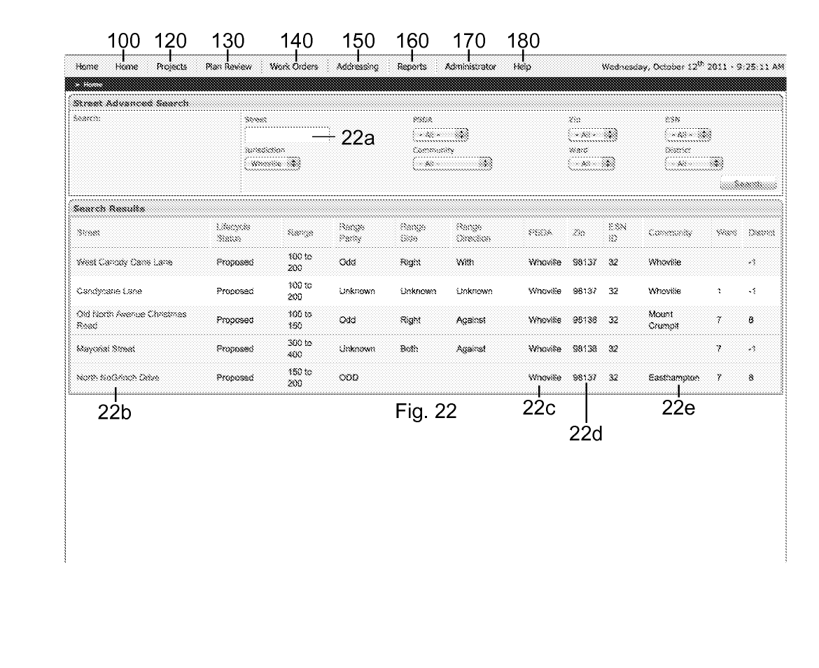

Under the “Addressing” heading, the user can also select the “Edit Streets” option and be directed to a page schematically illustrated in FIG. 22. The jurisdictional user is directed through several steps for conducting an advanced street search. The user enters the street's name in box 22a and then makes selections of a zip code, jurisdiction, community, wards, district and other available information. The search results are displayed in the lower part of the screen, where the street name, as in 22b, the township, as in 22c, zip code, as in 22d, ward number and district name within a city can be identified in the respective boxes 22e.

The system is configured to have a module allowing administrators to maintain the address book. The administrator clicks on the heading 150 “Addressing” and selects the “Address Book” subheading from a drop-down menu. This brings a customer to a page schematically shown as FIG. 23. From that page, the customer can add new contacts, addresses, telephone numbers, and update the existing contacts by clicking on the icon 23a “update.” If any information is incorrect the customer can remove the page by clicking a button 23b “Cancel” and enter a new address. The update choice would allow the user to update either mailing address, or telephone, or email of the primary contact.

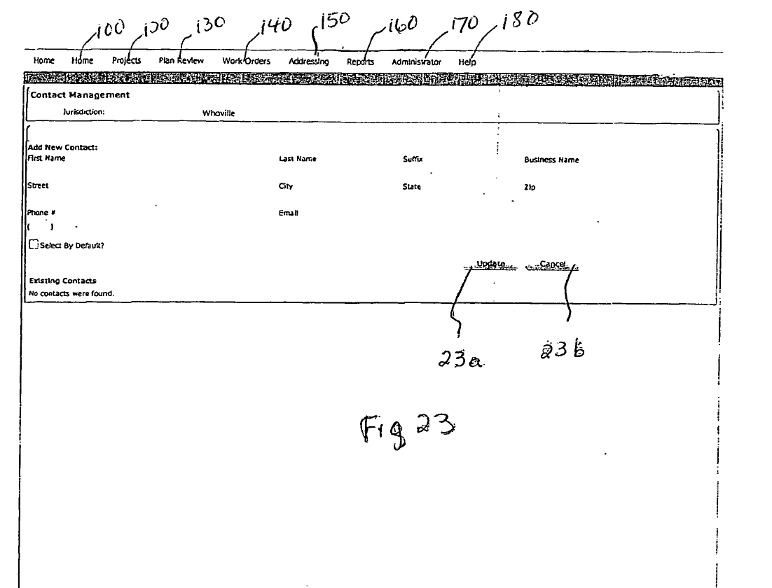

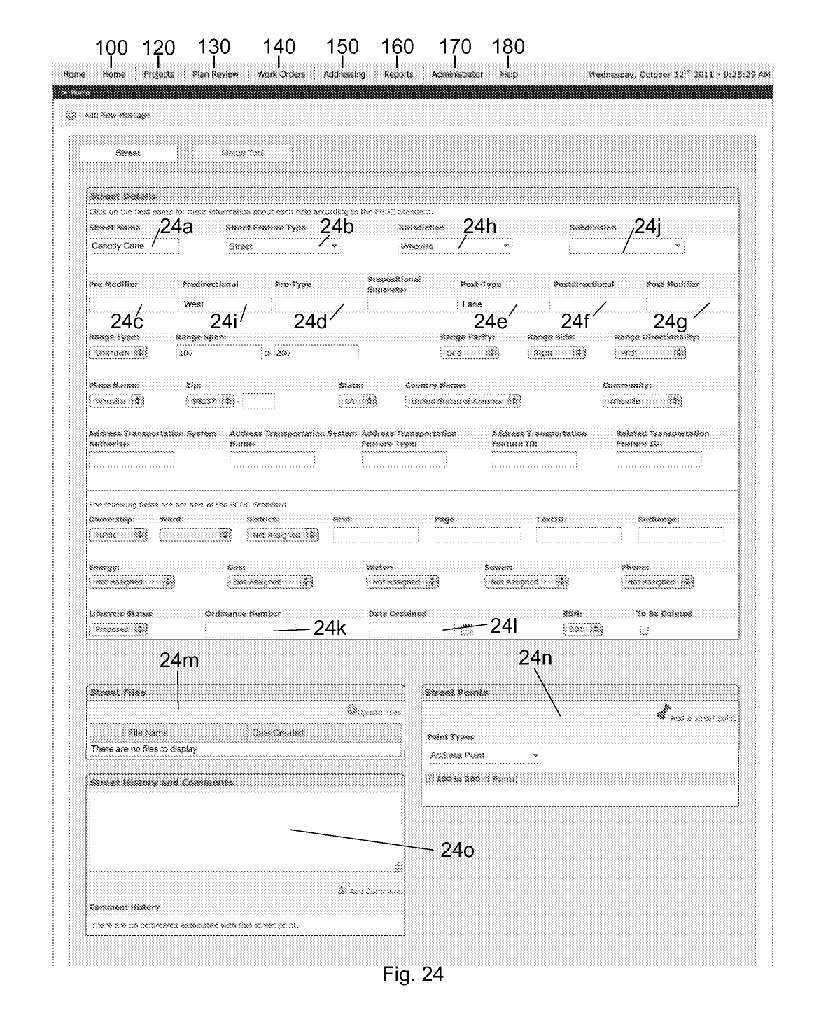

The system of the present invention has a module, which permits administrative editing to create a new street address for entering into database 12 by following several steps schematically illustrated in FIG. 24. This module is accessible from the heading 150 “Addressing.” The user is requested to enter the street details, that is the street name in box 24a, street type (street, road, lane) by choosing from a dropdown menu in box 24b and then choosing to either enter brackets or suffix for street name by entering the information in boxes 24c, 24d (prefix name), 24e (suffix type), 24f (suffix direction), and 24g (suffix name). The jurisdiction is selected from a dropdown menu in box 24h and the direction of the street (north, south, east or west)—in box 24i. The user also enters the name of the subdivision in box 24j and the city ordinance number in accordance with which a new street is created by entering the number in box 24k. The date of the ordinance is entered in box 24l. The system will then create a file for the street and display the file in box 24m, indicating the file name and date of creating the file. The “Street Points,” with the “Point Type” is displayed in box 24n Building or vacant lot). If necessary any comments can be added in box 24o. The customer can then either save the created street name by clicking on button 24p “Save,” or “cancel the file” by clicking on button 24q or delete the entire entered information by clicking on a button 24r.

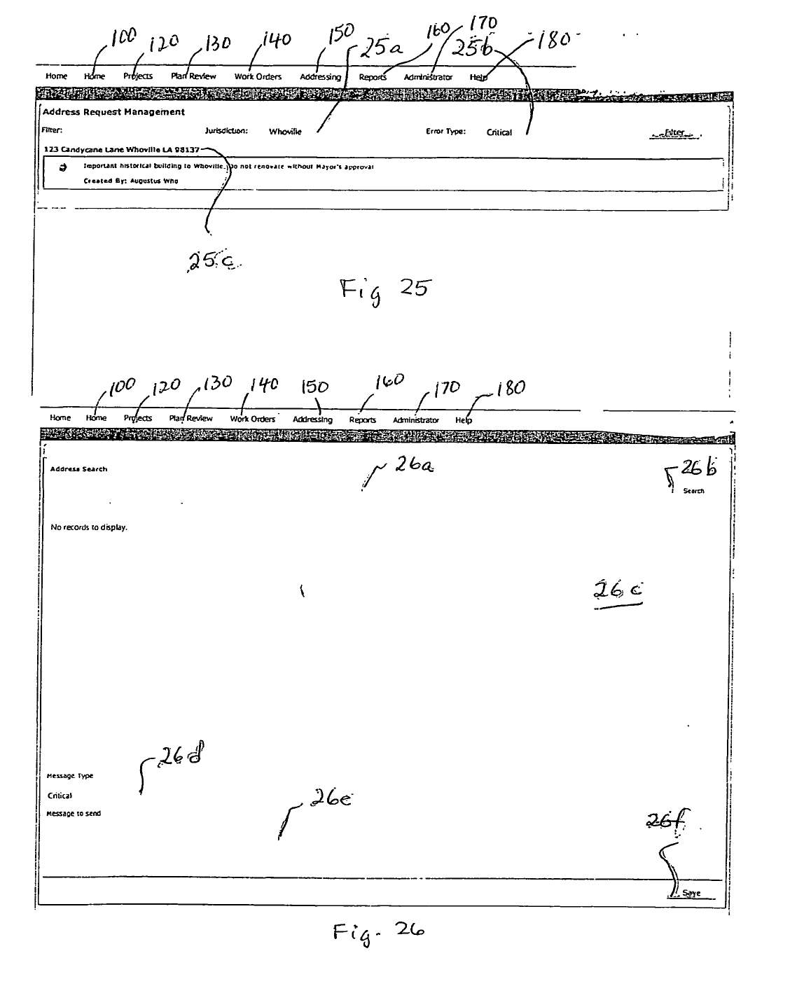

FIG. 25 schematically illustrates a process of “Address Request Management” that can be chosen from the drop-down menu under the heading 150 “Addressing.” When the customer clicks on the “Address management” choice, the customer is directed to a page schematically illustrated on FIG. 25. There, the customer can filter the request by entering the name of jurisdiction in box 25a and identifying the error type from a drop down box 25b. There, the customer is allowed to select the type of error, whether it is informational, warning, critical or all of the above. In the example shown in FIG. 25, the messaging pertains to a fictitious address of “123 Candycane Lane, Whoville, La.” shown in this illustration in line 25c in FIG. 25.

FIG. 26 schematically illustrates a step of creating an error report using the system of the present invention and accessing the system through the “Addressing” heading 150. When the user selects “Create Error Report” from the drop-down menu the system takes the user to the page where the address search for the property associated with creating an error report is located. By inputting the address of the property in box 26a and clicking on the search button 26b, the user will receive information on any existing error report associated with the property. Any such existing error report will be displayed in box 26c. In the example shown in FIG. 26, no records were found to display. The user can then identify the message type to be sent to the administrator from a drop down menu in box 26d and select one from “critical,” “warning,” or “information.” An optional step of generating a message regarding the error reporting can be introduced in box 26e. The user then is allowed to send the error reporting by clicking on button 26f “save.” The sent information will be stored in the database 12 and be available to the user next time the user accesses the system.

The “Reports” heading 160 in the tool bar of the system software allows the user to access another logic module and created different reports, including financial, permits, inspections, plan review, custom, GIS, contractors, and addresses. When making a “Financial” choice from the dropdown menu under the “Reports’ heading 160, the user has an option of selecting reports on fees collected according to the particular file, overages and underages, fees collected in total, generating a permit invoice, generating an end of day report, and accessing a fee breakdown.

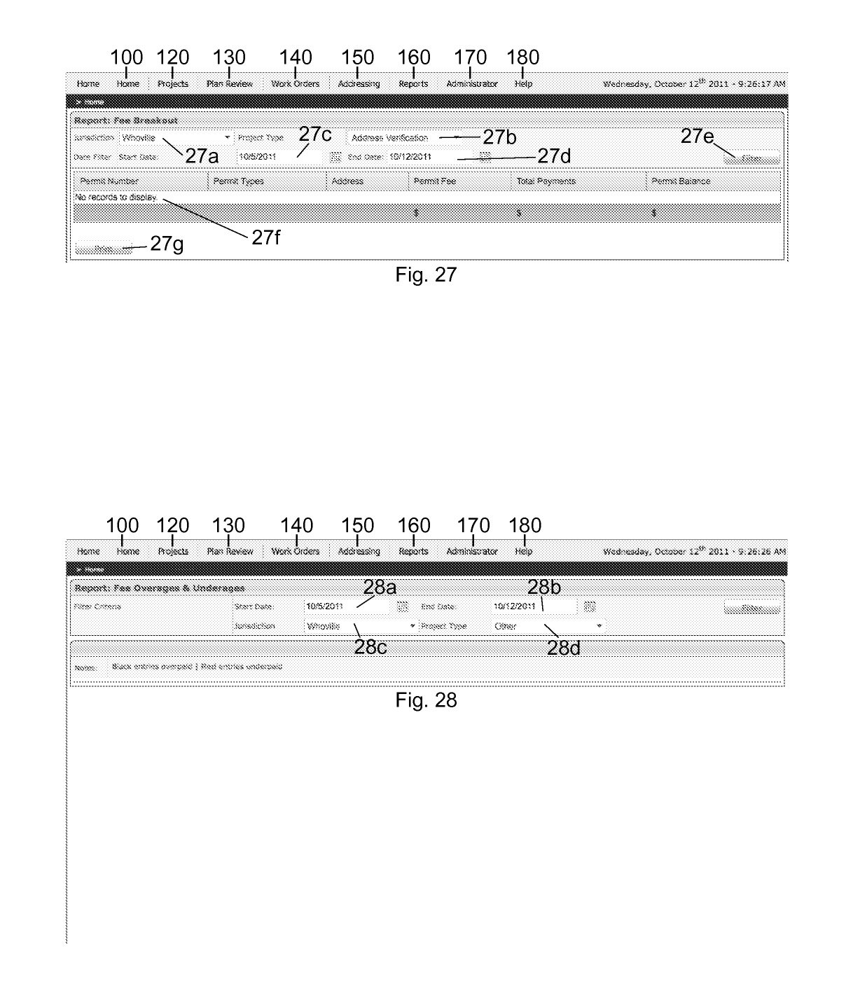

The first choice under the “Financial” sub-heading in the Reports” heading 160 will bring the user to a page schematically illustrated in FIG. 27. The user can filter the requested information by entering the jurisdiction name in box 27a, a project type in box 27b, a start date of the project in box 27c or an end date of the project in box 27d. The project type can be selected from another dropdown menu such as “address verification, “code enforcement,” “permit,” or “variance”. Once the user clicks on the “Filter” button 27e, the system retrieves the records and displays the records in line 27f wherein the permit type, address, permit fee, total payments and balance owed jurisdiction are displayed. The user will also have a choice of printing the retrieved information by clicking on the “Print” button 27g.

If the jurisdiction user made a choice of generating a financial report based on “Overages and Underages” the system directs the user to a page schematically illustrated in FIG. 28. There, the user can filter the search criteria by entering the start date of the requested report in box 28a, an end date of the report in box 28b, jurisdiction in box 28c, and the project type in box 28d. The project type can be selected from a dropdown menu which includes such subheadings as “commercial,” “new construction,” “commercial renovation,” “residential new construction,” “residential renovation,” “electrical,” “plumbing,” “mechanical,” “fixtures,” “septic tank,” or “other.” In the exemplary view of FIG. 28, the chosen project type is “other”.

Once the user clicks on the filter button 28e, the system generates the records and displays them in the lower portion of the screen, showing the overpaid amount in black and underpaid amounts in red.

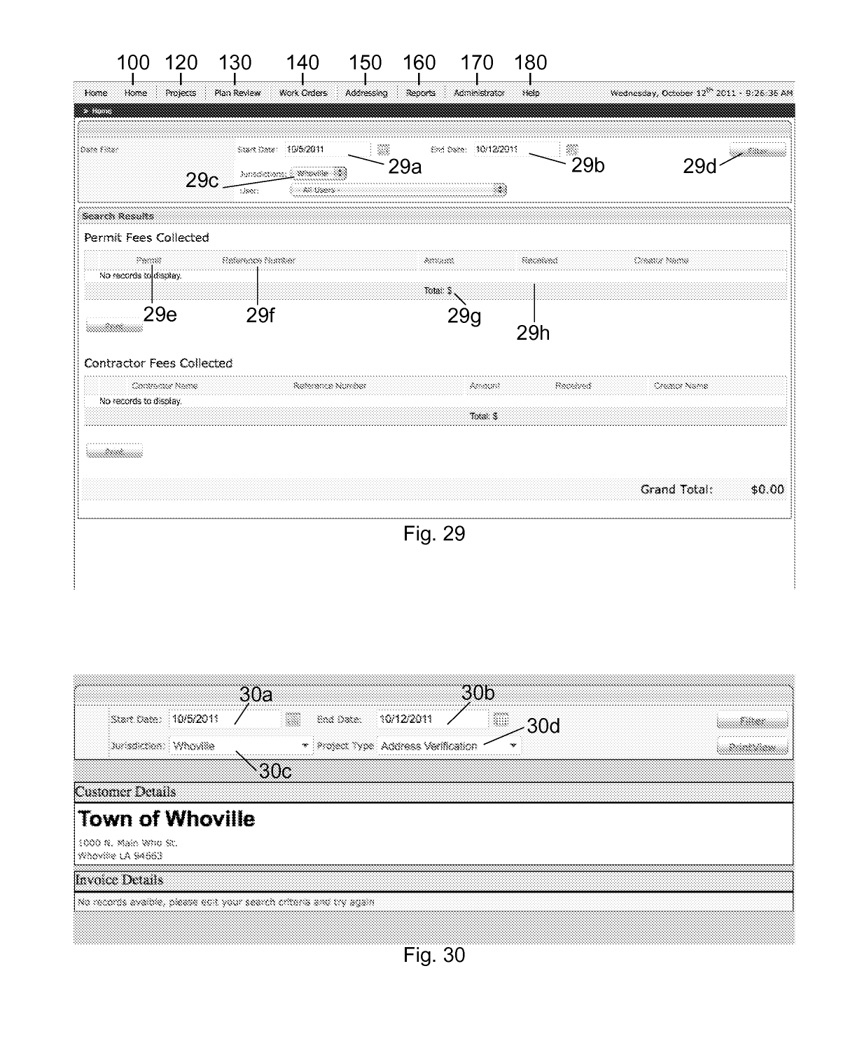

The “Permit Fees Collected” report module can be accessed from the “Reports” heading 160 in the system. A page, similar to FIG. 29, allows the user to filter the requested report by the start date in box 29a, an end date in box 29b, and a jurisdiction name in box 29c. The user clicks on the “Filter” button 29d and a report is generated for display in the search results. The report contains the information on the permit number in line 29d, the reference number for the project in line 29e, the amount due for the project in box 29f, and the amount received by the customer in line 29g. The system also displays, in the computer monitor, the report creator's name, which is displayed in box 29h. The report can be printed and sent to the customer, or placed in a paper file if such paper file exists for the particular project.

This system also allows the jurisdictional user to create an invoice by choosing an appropriate subheading from the “Reports” heading 160. In such a case, the user is directed to a page, which looks similar to the schematic view of FIG. 30, where the user filters the data by the start date in box 30a, the end date in box 30b, the jurisdiction in box 30c, and the project type in box 30d. The project can be any of the projects undertaken by the jurisdictional user, such as address verification, code enforcement, permit, variance; hazard mitigation, zoning, subdivision, back flow prevention, occupational license, community services, important data, or miscellaneous projects. In the example shown in FIG. 30, the project type is indicated as “address verification.” The invoice contains customer details as well as the name and address of the jurisdiction, which generated the invoice.

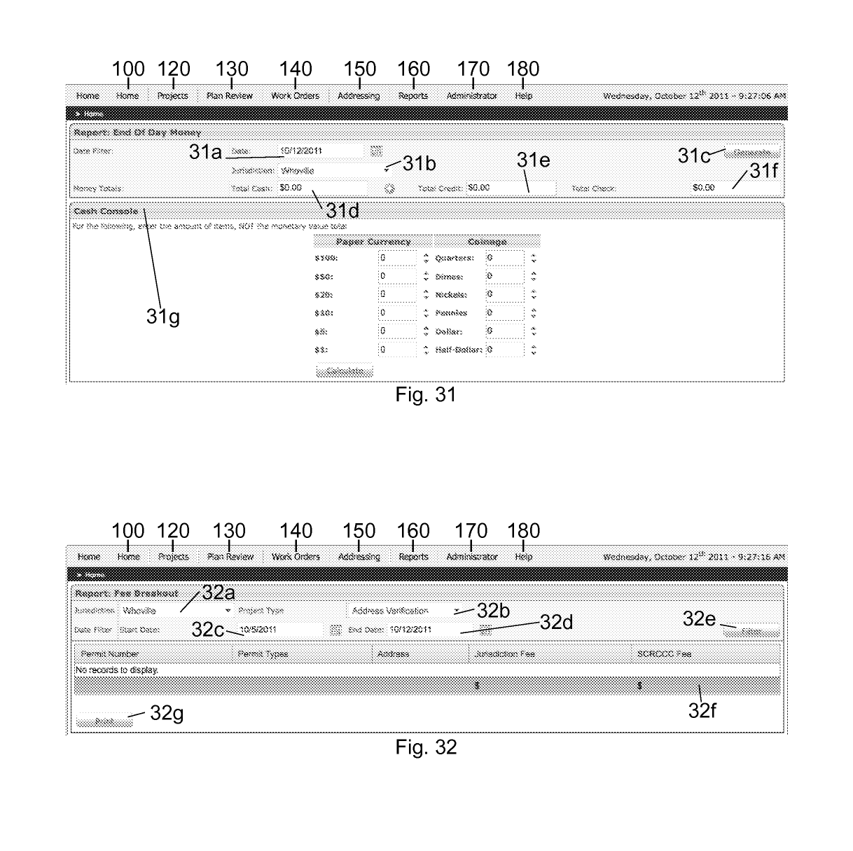

The “Financial” sub-heading can also generate an end of day financial report similar to a report schematically shown in FIG. 31. There, the user filters the data by the date created in box 31a, jurisdiction name in box 31b. By clicking on “Generate” button 31c, the user sends instructions to the system to create a report based on the total cash, which is reflected in box 31d, total credit—in box 31e, and total checks—in box 31f. If the jurisdiction received cash from the customer, the “Cash Console” 31g in the lower part of the page seen on the computer monitor allows the jurisdiction to keep track of the received funds. The user is requested to list the type of currency and coins received from the customer. The total amount in the “Cash Console” should match the “Total Cash” listed in box 31d. It is envisioned that this particular feature will be advantageously used by jurisdictions where the customer are allowed to come to the offices of the permit issuance authority and pay the required fees in cash.

The user can also create a “Fee Breakout” report collected in accordance with South Central Regional Construction Code Counsel (SCRCCC) regulations, the report resembling a schematic view of FIG. 32. The report of the “Fee breakout” is generated based on a jurisdictional input by the customer in box 32a, the project type in box 32b, the start date of the reporting period in box 32c and the end date in box 32d. By clicking on the “Filter” button 32e, the user sends a signal to the system to generate SCRCCC fees breakout report based on the permit type, address, jurisdiction fee, and the SCRCCC fee in box 32f. The report can then be printed by clicking on the “Print” button 32g. The report can be archived or used for fee justification.

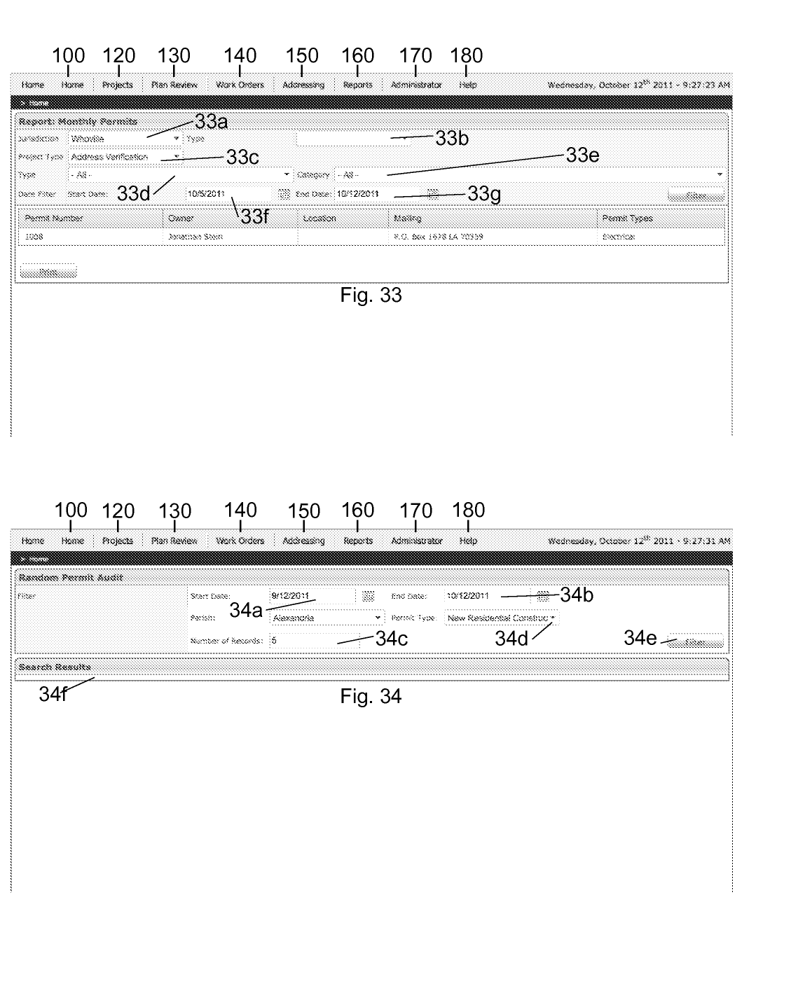

A “Monthly Permits” report can be generated in the submenu under the “Reports” heading. The permits can be accessed based on monthly timeframe, random permit audit, weekly permit, environmental management permit (EMP) summary, EMP summary by type of project, permits by counsel district, building permits by type, open permits, and permits summary by category. A command to generate a monthly permit report will produce a page similar to a page shown in FIG. 33, where the user chooses a jurisdiction by entering the jurisdiction name in box 33a, the type of permits in box 33b, the project type inbox 33c, the type of report in box 33d, and the category of report in box 33e. The user can filter the requested the information by entering the start date for the report generation in box 33f and an end date for the report generation in box 33g.

After the user clicks on the “Filter” button 33h, the system generates reports for the selected month and displays the report in the lower portion of the screen. The type of projects, for which these types of reports is made, is selected from a group consisting of address verification, code enforcement, permits, or variance. The type of report based on the permits can be either “residential” or “commercial.” The generated displayed report will show the permit number, owner, location, address and permit types. The report can be printed or viewed, depending on the user's preference.

The jurisdictional user can also perform “Random Permit Audit” by selecting the appropriate line in the dropdown menu under the “Reports” heading. The random permit audit report will look similar to the schematic view shown in FIG. 34. On a computer screen, the user first enters the start date of the audit by entering it into box 34a, the end date of the audit in box 34b, parish or county in box 34c, and the permit type in Box 34d. The permit type can be selected from a dropdown menu containing various types of renovation projects (residential or commercial, auxiliary structure, additions to the structure, parking lot construction, build out, right of way permits, driveway permits, development permits, demolition permits, trailer placement permit, swimming pool permit, grading permit, vendor placement permit, zoning compliance permit, sign permit, electrical, plumbing or water permit, gas permit, mechanical permit, new construction, existing construction, electrical work or gas work). Of course, the dropdown menu of the permit type can differ depending on the type of permits that the ordinance allows the jurisdictional authority to issue. By clicking on the “Filter” button, 34a, the user sends a signal to the system to generate a selected type of permit audit report. The results of the audit report will be displayed in the lower portion of the computer page as in 34f.

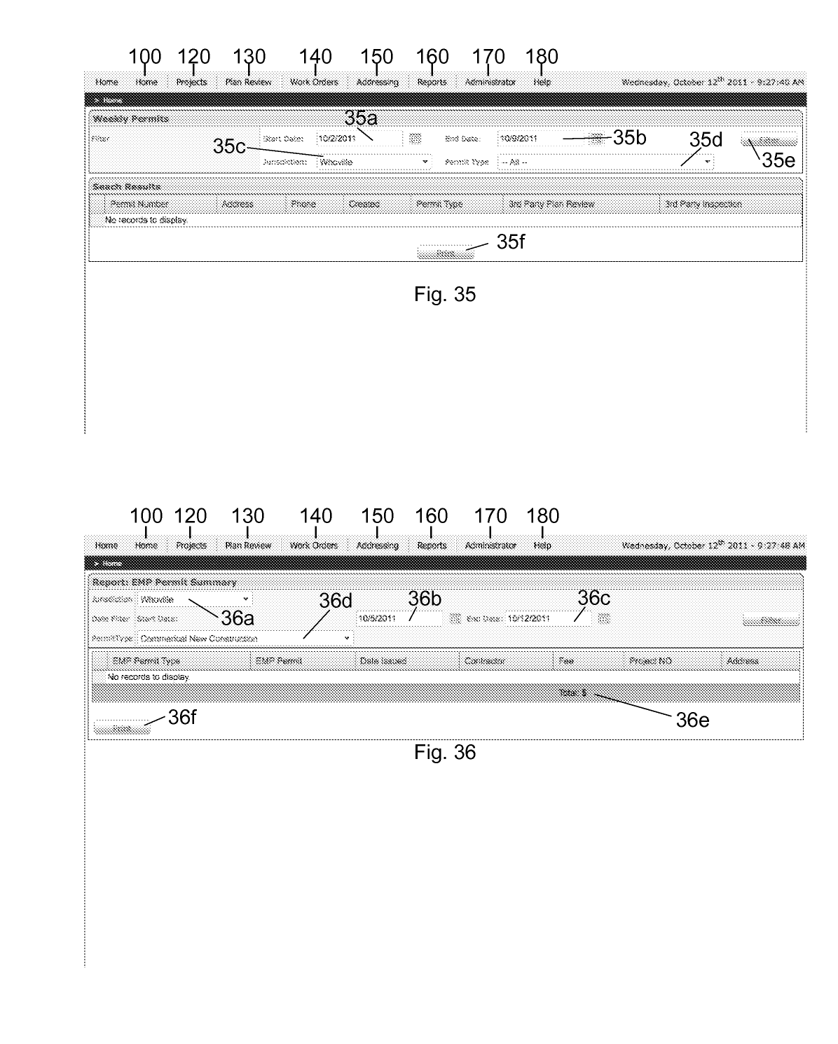

A weekly summary report can be generated by filtering criteria and filling in the boxes on a computer display page similar to the schematic view of FIG. 35. The user filters the search criteria of report to be generated by the start date in box 35a, the end date of the report in box 35b, the jurisdiction name—in box 36c, and the permit type—in box 36d. The permit type, as described above, can be residential, commercial, new construction, renovation, electrical, plumbing, mechanical, fixtures, sewer, septic, and any other type permitted in the particular jurisdiction. The user then clicks the “Filter” button 35e, and the weekly summary report is generated. The search results are displayed in the lower portion of the screen based on the permit number, address, and telephone contact number, name of the person creating the permit type and any third party review or inspection in the respective line under the “Search Result.” Such permit reports can be printed by clicking on a box 35f shown in FIG. 35.

An environmental management permit (EMP) summary can be accessed by selecting the appropriate submenu in the “Permit Report heading. A page similar to the page schematically illustrated in FIG. 36 is displayed wherein the user filters the requested report by the jurisdiction name in box 36a, the start date of the report—in box 36b, the end date—in box 36c, and the permit type in box 36d. The EMP Permit Summary report is displayed using the EMP Permit Type, EMP Permit number, date issued, contractor's name, the amount of fees, Project number and address of the project. The total value of EMP permits is displayed on line 36e. This report can be printed by clicking on the “print” button 36f as shown in FIG. 36.

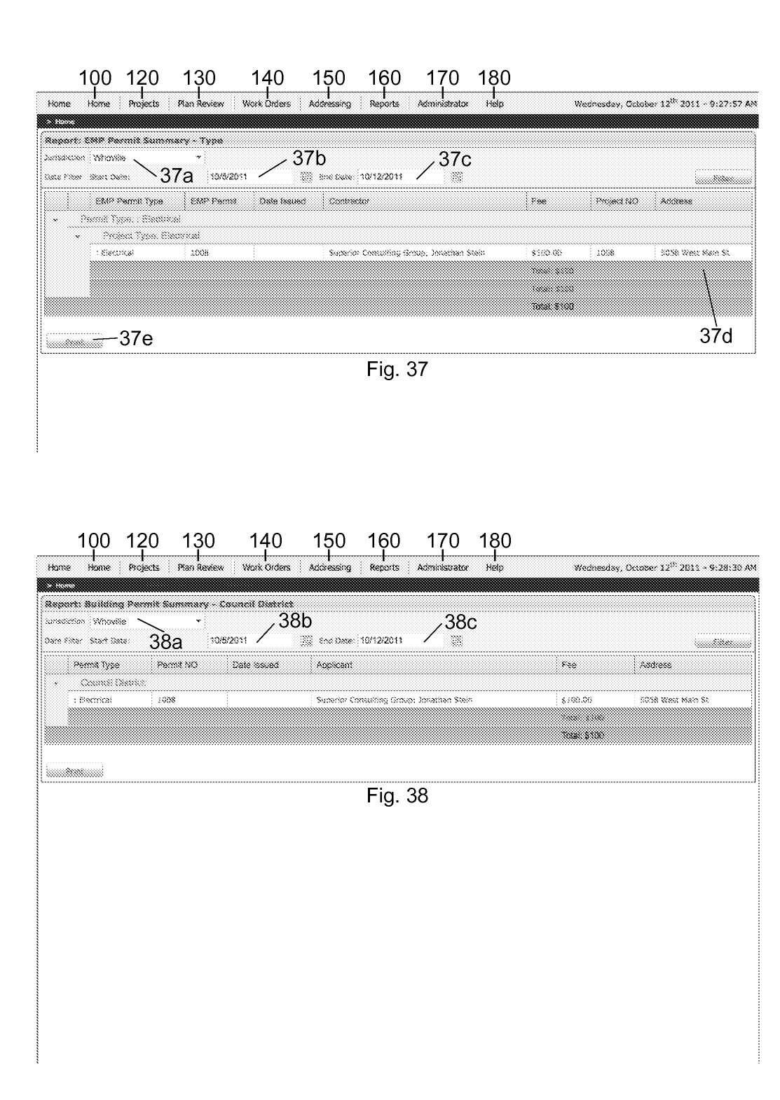

The “Reports” heading has a sub-heading for EMP Permit Summary allows retrieval and creation of the permit summary based on the type of permit issued. In the schematic illustration of FIG. 37, the user first filters the database information using the jurisdiction name in box 37a, the start date—in box 37b, and the end date—in box 37c. Once the basic filtering step is completed, the system software creates a report using the EMP Permit Type, EMP Permit Number, date Issued, Contractor's name, Fee generated, Project number and address of the property, which is associated with this property. The total value of the EMP report of the particular type is then displayed on line 37d. This report can be printed by clicking on the “print” button 37e as shown in FIG. 37.

The “Reports” heading 160 has a sub-heading entitled “Building Permit Summary—Council District,” which allows the user to generate and display records pertaining to a specific district within the jurisdiction. This step is schematically illustrated in FIG. 38. As before, the user filters the information based on the jurisdiction in box 38a, the start date for the report in box 38b, the end date of the report—in box 38c.

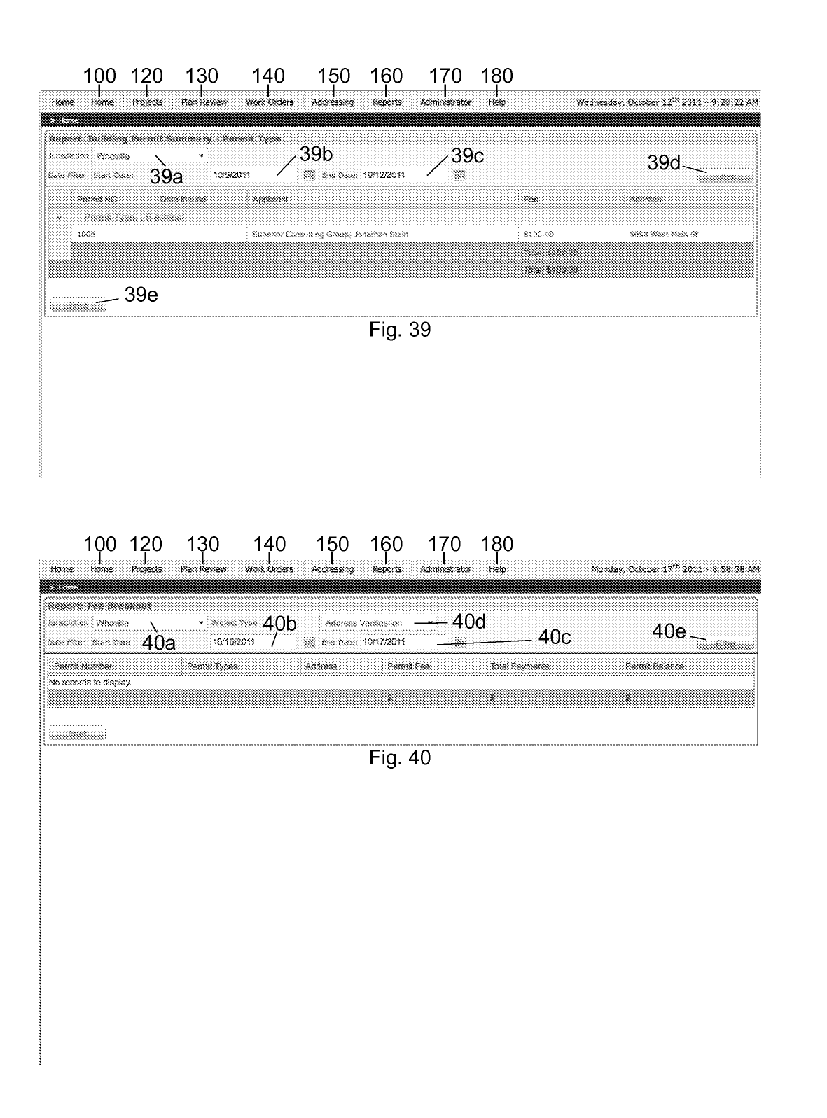

Another step that the user can take under the heading 160 “Reports,” subheading “Building Permit Summary by Permit Type” is to generate and view a report based on the types of permits issued within the jurisdiction within a specific time period. To achieve this step and the narrow the search, the user accesses the page created by the system software and schematically illustrated in FIG. 39, where the user filters the search results by entering the name of the jurisdiction in box 39a, the start date of the report in box 39b, and the end date of the report—in box 39c. After the user send the request by clicking on the “Filter” button 39d, the system retrieves and displays, on the computer screen, the retrieved records classified by the Permit Number, date Issued, Applicant's name, Fee, and Address of the property. The total value of the fees generated by the particular permit type (building permits) is also displayed. The generated report can be printed using the “print” button 39e.

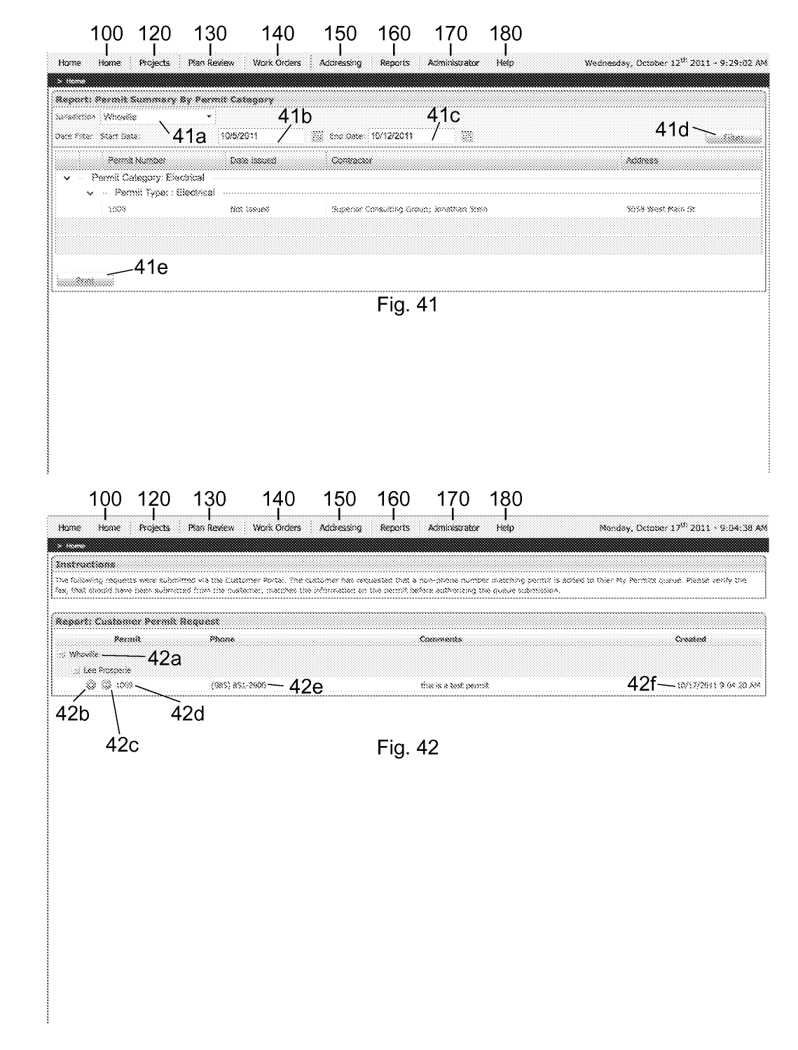

FIG. 40 schematically illustrates a step of creating and displaying the report based on a fee breakdown. The report will retrieve the records so long as the permit is not marked as expired, or void, or the permit's certificate of occupancy has not been marked as issued. These limitations are displayed in the “Filter’ portion of the screen. As before, the user can limit the number of retrieved results by filtering the database records by the name of the jurisdiction in box 40a, the start date—in box 40b, and the end date—in box 40c. If the user checks the box 40d “Show Only Issued Permits” the system will disregard all types of permits except the permits designated as “issued.”

Once the user clicks on the “Filter” button 40e, the system retrieves and displays on the computer screen, the records found in the database 12. The records are organized according to the permit number, name of the jurisdiction, type of permit, designation, address, whether the fees were received, created, or issued. Based on the information, the jurisdiction can easily identify the amount of fees generated from the issuance of permits, the type and geographic location of the permits. This report can also be printed.

FIG. 41 schematically illustrates a step of creating and displaying a Permit Summary by Permit Category Report. In this step, the filtering criteria are the name of the jurisdiction (box 41a), start date (box 41b) and end date (box 41c). The report is generated and displayed on the computer screen with the information including the permit number, date issued, the name of the contractor and the property address, all of which can be displayed in the respective columns in line 41d. This report can be printed by clicking on the “Print” button 41e.

The “Administrator” heading 170 in the toolbar can be used by the administrator, the jurisdictional user, to fix duplicate permit records, if such exists, as well as view the customer permit request list. One such list is shown in the exemplary embodiment of FIG. 42. The system notifies the administrator that the listing requests were submitted through a customer portal side of the portal 16 and that the customer has requested that a non-phone number matching permit be added to their request. The system also advises the administrator to verify the fax number of the permit request so that the fax number matches the information on the permit before authorizing the queue submission. In the exemplary view of FIG. 42, fictitious customers under the names of Lonnie Lachney, Jason McClown, etc. are listed along with fictitious fax numbers. The collapse-and-expand icon 42a allows the administrator to collect or expand the entry under a particular customer's name. A “plus” button 42b, when clicked on, approves the request while the “minus” button 42c when clicked, denies the request.

The column 42d lists the number issued to the permit request by the system. This number was auto generated when the customer applied for a permit. If the jurisdictional user clicks on that number, the user will be taken to a page similar to FIG. 3, wherein all details about the project are displayed. The fourth column 42e lists the facsimile number provided to the jurisdiction by the customer. The date column 42f “Created” lists the date when the file request was generated. The jurisdictional user has an opportunity to leave various comments on the page, some of the comments are shown in FIG. 42.

The Administrator heading 170 also allows the jurisdictional user to download various software programs and applications associated with the system software, such as Adobe/plug-in, a portion of the program entitled “Inspection Anywhere,” as well as various documents, such as a general flier, handouts and the like.

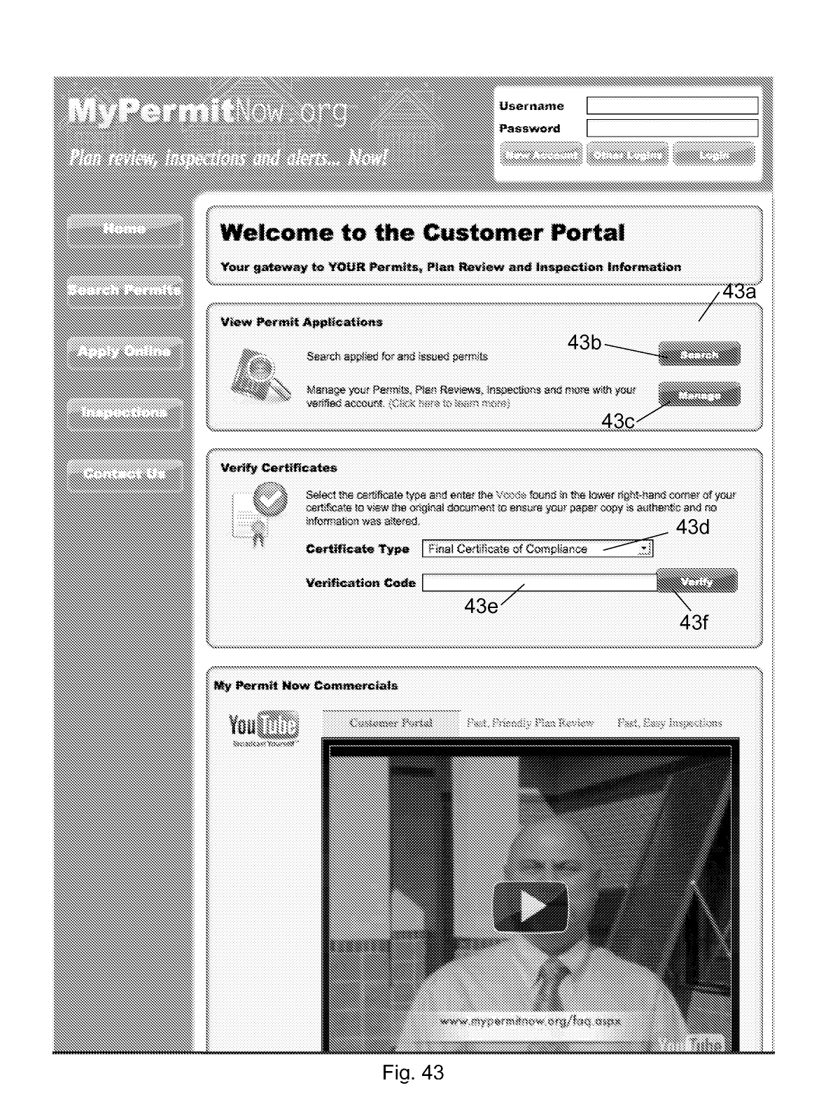

The customer side of the portal 16 brings the customer to a “Welcome” page from which the customer can submit and view permit applications, manage the customer's permits, print reviews, inspections, as well as verify certificates issued to the customer for the customer's projects. A page, schematically shown in FIG. 43, can be accessed by a customer through the portal 16. In the portion “View Permit Applications” 43a, the customer has a choice of downloading permit applications from a SCRCCC member jurisdiction.

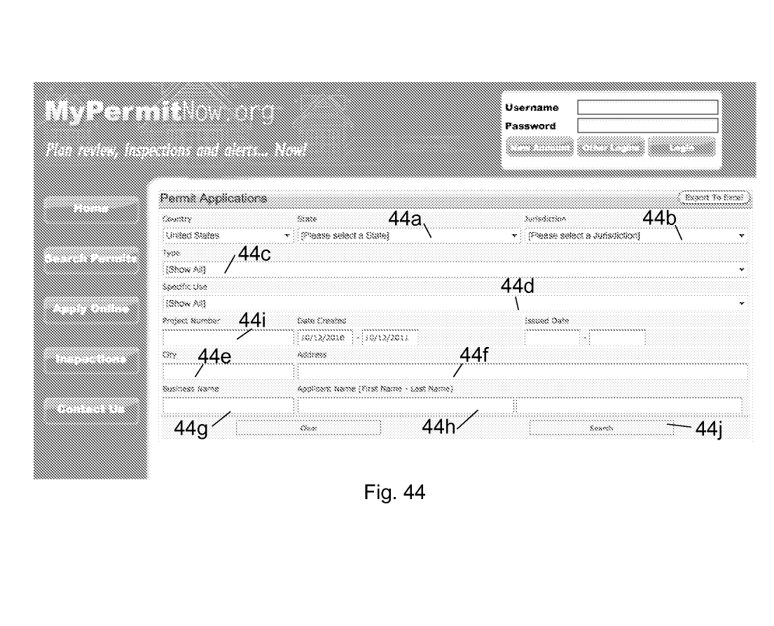

By clicking on the “View” button 43b, the customer accesses a page schematically shown in FIG. 44. The customer selects the state where the project for permit is located from a drop down menu 44a, then a jurisdiction from dropdown menu in box 44b. The type of permit can be chosen from a drop down menu in box 44c, the specific use, if any, can be chosen from a dropdown menu in box 44d. The customer also can choose the address of the property in boxes 44e and 44f, as well as list the customer's name in box 44g and physical name on the applicant in box 44h. If the customer knows the project number, that number should be introduced in box 44i.

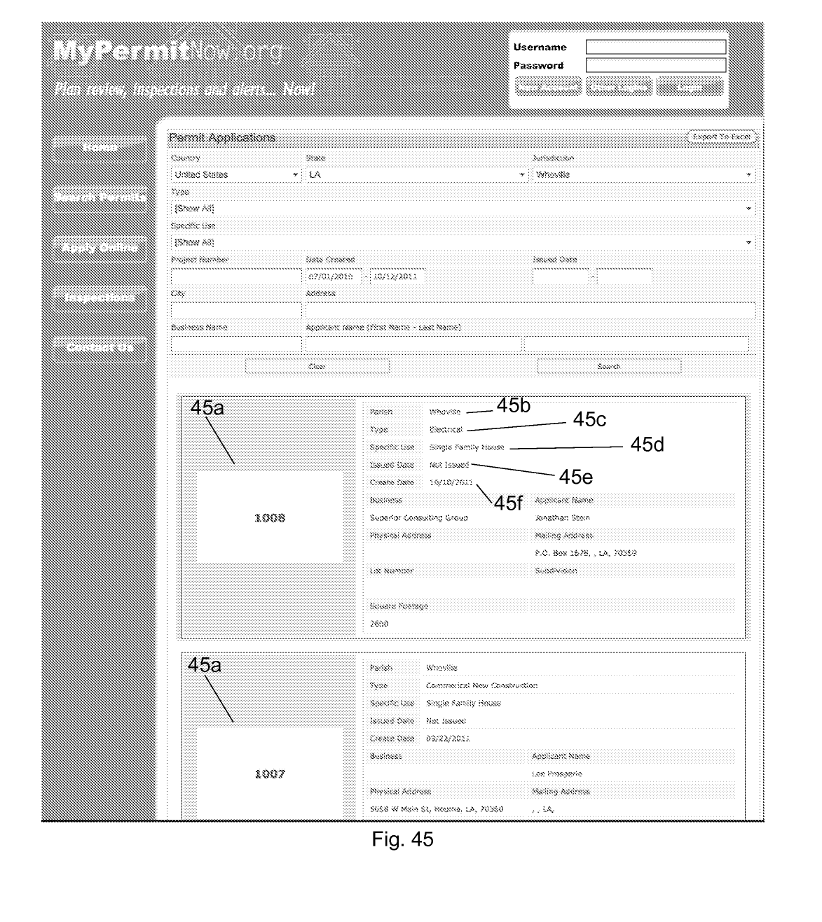

The customer can then click on the “Search” button 44j, which will bring the customer to a page schematically shown in FIG. 45. There, the customer is given a list of permit applications found under the customer's name, with the permit numbers shown in boxes 45a. Depending on the number of permit applications, the list can be either one entry or several entries, particularly for a general contractor. The details of the permit are listed by the county or parish in line 45b, the type of permit in line 45c, any specific use in line 45d, the date of issue in line 45e and the date of creating the file in line 45f. The particulars of the applicant, whether it is a business, a physical entity, and the applicant's physical and mailing addresses are listed in the assigned field, as shown in FIG. 45.

If the customer clicks on “Add to My Permits” button 45g, the customer will add the particular file to the permits that will be retrieved next time the customer accesses the system. If the customer wants to create a work order and schedule an inspection, the customer can click on “Create Work Order” button 45h.

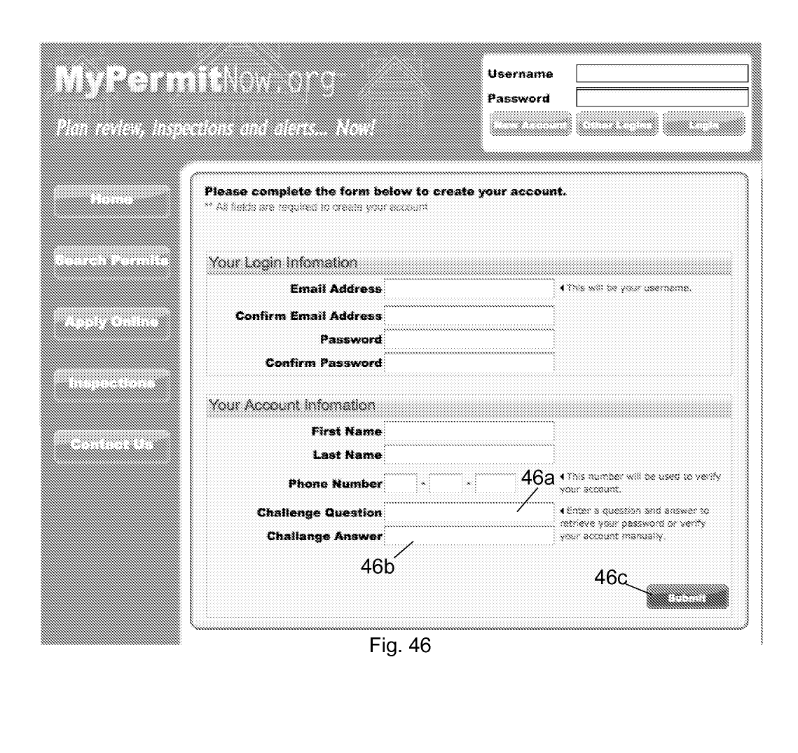

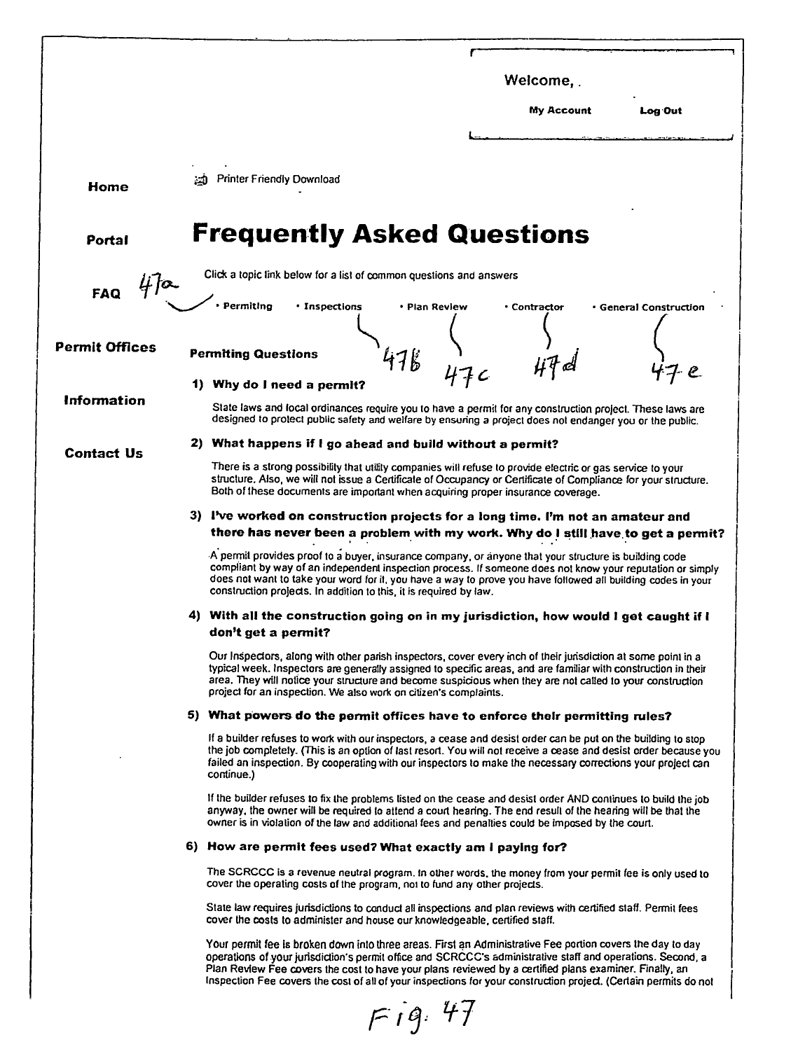

From the portal page shown in FIG. 43, the customer can manage the permits by clicking on a button 43c. The system software brings a customer to a page schematically illustrated in FIG. 46. There, the customer can create an account by inputting the customer's name, telephone number, email address and selecting a password. For security purposes, the customer is also requested to create a “challenge question” and list it in box 46a, as well as a “challenge answer” by listing it in box 46b. Once the customer fills in all the required fields, the customer can click on the “Save” button 46c, thereby creating an account within the system. The customer can then log in the jurisdictional/customer portal 16 at any time.

An additional feature of the customer portal side of the portal 16 is the ability for the customer to verify certificates issued by the jurisdiction. A box “Certificate Type” 43d has a dropdown menu which can list various types of certificates issued by the jurisdiction. In the exemplary view of FIG. 43, the certificate entitled is “Final Certificate of Compliance” which is issued once all the requirements of the ordinances and the code have been satisfied, is listed. The customer is then requested to enter the “verification code” in box 43e. By clicking on the “Verify” button 43f, the customer is directed to a page which will confirm or reject the certificate of compliance.

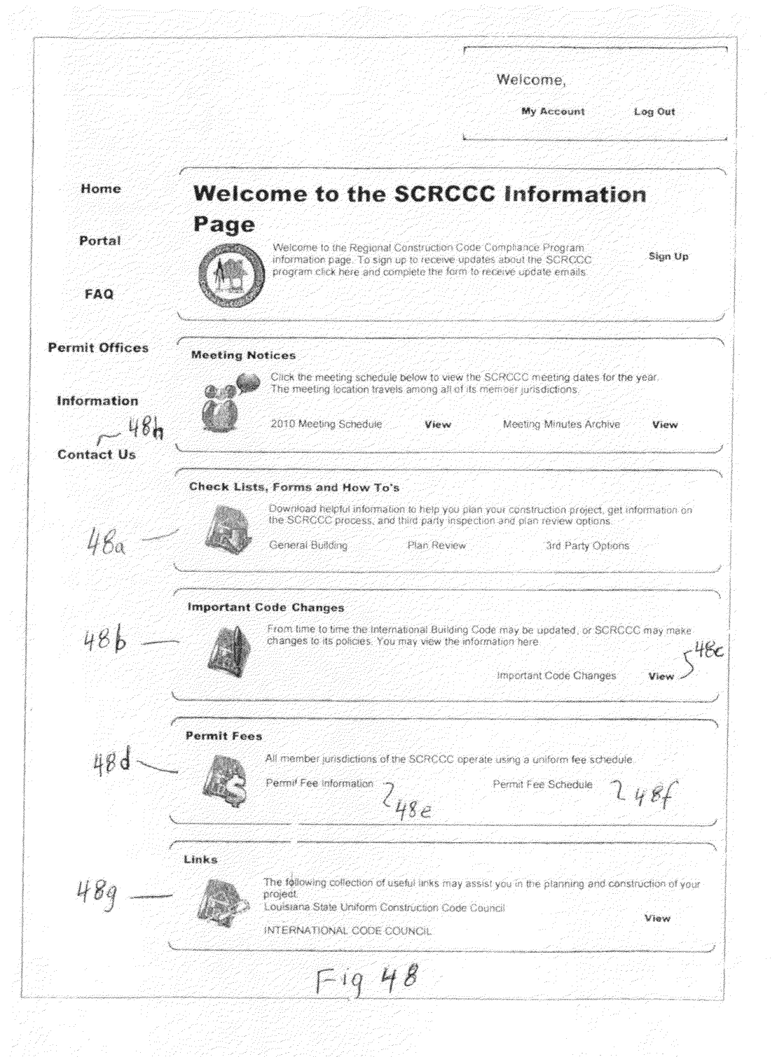

The system software of the present invention provides an opportunity for the jurisdiction to create a section on the website entitled “Frequently Asked Questions” (FAQ). The informational part of the portal is designed to assist the permit applicant to mitigate through the permit applications office and ask basic questions. One of the pages, which opens under “Frequently Asked Questions” box 43g in FIG. 43 is illustrated in FIG. 47.

As can be seen in FIG. 47, the customer has a choice of selecting the questions pertaining to permit process by clicking on column 47a, a question pertaining to inspections by clicking on heading 47b, a question pertaining to a plan review by clicking on heading 47c, a question pertaining to a contractor by clicking on heading 47d, and a question pertaining to general construction by clicking on heading 47e. The informational materials provided by the system of the present invention touches upon all aspects of governmental processes associated with construction or renovation of real estate property. Some of the “permitting” questions can relate to whether a customer needs a permit or is allowed to build, without a permit, discusses enforcement processes for permitting, the fees associated with applying for permits. The inspections questions can relate on how to schedule an inspection for a new construction or renovation, what is the process for scheduling inspections in specific order, and whether there is an appeal process under the jurisdiction regulations. The plan review information can pertain to the proper manner of drawing plans for the real estate site. The contractor questions can relate to the questions whether a particular contractor is licensed in the jurisdiction. The answers can relate to general construction questions, different aspects of building, constructing, erecting structures, pouring a slab, etc. at a construction site. Of course this list is non-limiting and any type of information the jurisdiction deems to be important for customer education and information can be introduced under the heading “Frequently Asked Questions.”

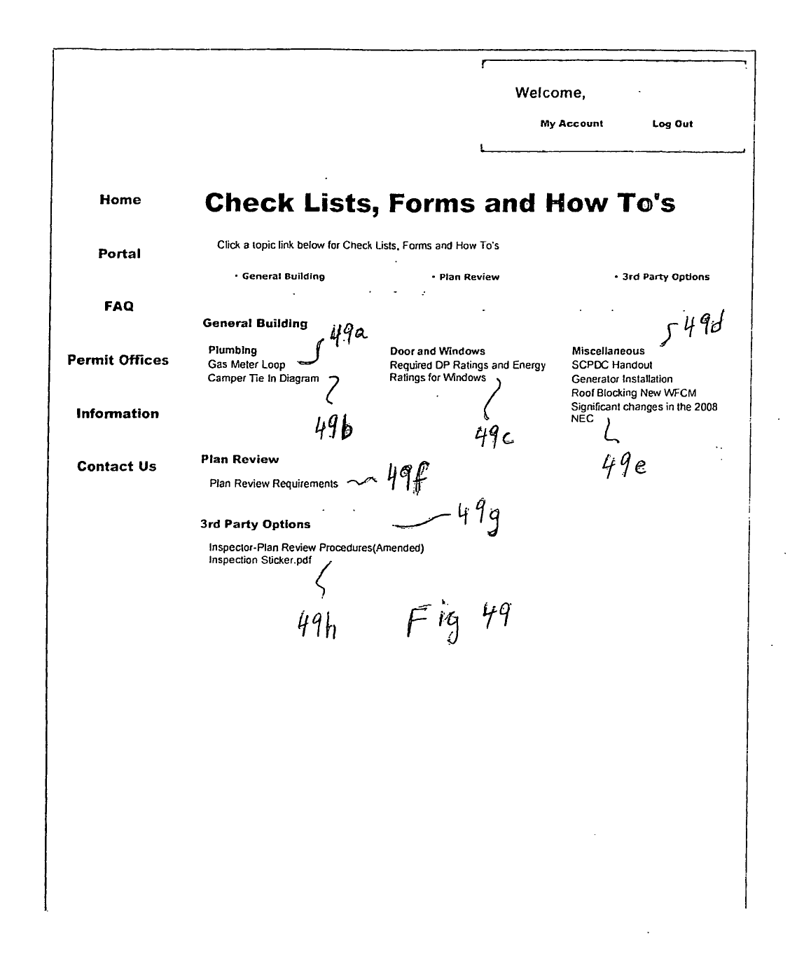

Box 43h provides a means for the customer to determine the addresses of the jurisdictional permitting offices in the parish, city, as well as SCRCCC code council. The “Information” box 43i brings the customer to a page wherein the jurisdiction posts notices of meetings, checklists for general building, land review and 3^{rd} party options, code changes, permit fees, as well as various links. An example of the “information” page is shown in FIG. 48.

One of the advantageous features of the system of the present invention is the provision of checklists, forms and how-to's that are schematically shown in box 48a. By clicking on the “General Building” subheading, the customer is directed to a page schematically illustrated in FIG. 49. There, the customer can receive access to various codes and ordinances. In the exemplary view shown in FIG. 49, the customer can get access to the SCRCCC plumbing codes, gas meter loop and Camper Tie In Diagram by clicking on lines 49a or 49b. The heading “Doors and Windows” brings the customer to a chart created by the South Central Regional Construction Code Council (SCRCCC) relating to design pressure rating (DP rating) and energy ratings for windows (a customer clicks on line 49c).

A “Miscellaneous” subheading 49d provides the customer with additional information, for instance, installation guidelines for power generators, roof blocking systems, and other systems, such as for instance national electrical code (NEC) that can be accessed by clicking on line 49e. The customer can click on line 49f and open a page entitled “Plan Review Requirements” that are established by the South. Central Regional Construction Code Council (SCRCCC). The “3^{rd} Party Options” subheading 49g gives a customer a choice of either selecting a “inspector-plan review procedure” established by the SCRCCC or to obtain an inspection sticker saved in a .pdf format and accessible to inspectors.

FIG. 48 also illustrates introduction of informational material by a jurisdictional authority. Box 48b “Important Code Changes” redirects a customer to a page where revisions or new code requirements are presented. By clicking on a “view” button 48c the customer can study such changes before undertaking a construction project. Box 48d provides a portal user, a member of the public, access to “Permit Fee Information” as shown in line 48e and “permit fee Schedule” by clicking on like 48f. The “Links” box 48g can be optionally provided to a portal user. In the exemplary schematic of FIG. 48, two active links are shown: Louisiana State Uniform Construction Code Council and International Code Council. Other links to governmental and regulatory authorities can be incorporated into the system, as well. The “Contact Us” button 48h will direct customer to contact information for the particular jurisdiction.

In this system, the portal 16 represents a means for use by the system users and their customers for the purpose of monitoring and managing objects they own or control. The jurisdictional entities access the database 12 through the gateway or portal 16 and security layer that is individual for each jurisdiction. Each jurisdictional entity only has access to records in the database 12 related to monitored objects within its jurisdictional borders. The jurisdictional entity that is granted access to the system 10 can retrieve, write or modify records related only to its own objects. The customers of the jurisdictional entities have limited access to the database and the system tools that can modify the records within the system.

Another category of users of the system 10 are third parties, which are not owners of the property that are monitored by the system 10. The third parties include, for example, licensed contractors, construction inspectors, safety inspectors, and others. The third parties operate and/or cooperate with the jurisdictional entities to provide services required to manage and monitor land use within the jurisdictional borders. Each entity in the system can also control access to information in the database 12 by its own departments, divisions or regional offices.

The system 10 is configured to be continuously updated through incorporation of new land use data. Data once uploaded and retrieved can be exported into a printed report format. The invention includes the ability for users to obtain the necessary building permits, research addresses, schedule inspections and submit plans for approval by the governmental agency. The system permits web-based interaction between the jurisdictional authority and its customers in an expeditious and efficient manner, saving time and human resources.

Embodiments of the disclosed invention include methods of segregating data. Embodiments of the invention include data mining and information retrieval within the typical labyrinth of zoning regulations, building codes and city ordinances. Users can click upon specific labels to obtain most up-to-date information applicable to the users and customers projects.

Many changes and modifications can be made in the system and method of the present invention without departing from the spirit thereof I, therefore pray that my rights to the present invention be limited only by the scope of the appended claims.

I claim:

1. Computer implemented system for monitoring land use activities, comprising:
a database comprising identification and description data of land properties within one or more selected jurisdictions, a computer executable logic module configured for monitoring and updating land use activities within the selected jurisdictions and for maintaining data in said database that are generated as a result of said monitoring by said logic module, wherein said data related to the land use activities in conjunction with a particular geographic location of said selected jurisdictions are any of: permit application for; and review of land use modification, plan review and approval for land use modification, and requests for, and inspection of land use modification for compliance with ordinances and regulations within the selected jurisdictions.

2. The system of claim 1, wherein said data related to the land use activities comprise any of: location of said land properties, name of a selected jurisdiction, permit application number, street address, description of land properties, mapping location, contact names and addresses associated with a specific permit application, type of land property associated with the specific permit application, type of land use modification, land property ownership, date of permit application, or category of permit application.

3. The system of claim 1, wherein said database further comprises a plurality of ordinances and regulations specific to selected jurisdictions, and wherein said ordinances and regulations pertain to land use activities within the selected jurisdictions.

4. The system of claim 1, wherein said data on permit application comprises any of: residential, commercial, new construction, renovation, electrical, plumbing, mechanical, fixtures, sewer, septic, fence, excavation, or pool.

5. The system of claim 1, wherein said plan review data comprises any of: category of plan review, residential, commercial, new, completed, in-progress, or contact name and address.

6. The system of claim 1, wherein said activity data is generated by authorized users within selected jurisdictions using applicant-submitted data and/or other activity data sets.

7. The system of claim 1, further comprising: an address verification module for executing steps to verify an address associated with a specific land use activity within one or more selected jurisdictions, wherein such steps comprise any of: checking against other data sources including mapping location, grid location, and municipal ordinances; requesting from one or more systems additional information needed for verification.

8. The system of claim 1, further comprising a search module for executing steps to identify a project associated with a specific land use activity and property within one or more selected jurisdictions, wherein such steps comprise any of: identifying a physical address of the property, checking against other data sources including contact name and address associated with the property, name of subdivision, lot number within the subdivision, date of application for land use modification, project type including address verification, backflow prevention, code enforcement, hazard mitigation, occupational license, permit, variance, zoning, and citation of code enforcement; requesting from one or more systems additional information needed for identification.

9. The system of claim 1, further comprising a search module for executing steps to create a project file to be stored in the database, wherein said steps comprise any of: identifying a jurisdiction from the selected jurisdictions; identifying a project type associated with land use modification; providing a description of the project; providing a physical address of a property subject of land use modification; providing contact name and address associated with the project; identifying files associated with the property within the database; providing type-of-permit information; providing land ownership and occupancy information; providing zoning information; providing flood zone information; providing, data about physical attributes of the property including description, size, construction type, structure, and parking; providing information on the type of property subject of land use modification; requesting the system to generate a project number; associating the project number with the project file.

10. The system of claim 9, further comprising a module for generating form letters to be sent to the contact name and address associated with the project.

11. The system of claim 9, further comprising a module for generating certificates of occupancy and completion to be stored in the database and to be sent to the contact name and address.

12. The system of claim 9, further comprising a module for executing steps to upload the project file into the system database, wherein said steps comprise any of: providing a file description; identifying a jurisdiction; identifying the project type; providing the project number; uploading the created file into the system database.

13. The system of claim 1, further comprising a module for executing steps to create a contractor file to be stored in the database, wherein said steps comprise any of: providing a name and address of a contractor; providing a license number of the contractor; providing license expiration date; providing state contractor number, providing state identification number and a type of license the contractor holds, including HVAC, framing, painting, foundation drilling, plumbing, electrical, heating, air conditioning, or concrete work; providing bond and insurance information of the contractor; saving the created file in the database.

14. The system of claim 13, further comprising a module for executing steps to search a contractor file within the database, wherein said steps comprise any of: providing a license number of the contractor; providing jurisdiction name, providing business name of the contractor and/or personal name of the contractor; providing a contractor type; and status of the contractor license; requesting from the system information needed for identification.

15. The system of claim 1, further comprising a module for executing steps to search a list of projects within a selected jurisdiction, wherein the steps comprise any of: identifying a jurisdiction, identifying a project number; identifying requirements to be completed within the project, including building code review and/or construction drawings submittal; requesting from the system the list of projects including completed and non-completed requirements.

16. The system of claim 1, further comprising a module for executing steps to search a list of plan review projects within a selected jurisdiction, wherein the steps comprise any of: identifying a project number; identifying a street address category of the plan review; identifying status of the plan review project; identifying a start and/or end date for the plan project; identifying name of contact associated with the plan review project; requesting the system to retrieve from the database a plan review file within any of the selected categories, including project number and category of the project; uploading revisions associated with the retrieved file; reviewing and generating notes for plan review file.

17. The system of claim 16, further comprising a module for executing steps to search plan review projects within a selected jurisdiction, wherein the steps comprise any of: identifying the plan review project number; identifying address and contact name associated with the plan review project; identifying start and end date of the plan review project; requesting the system to retrieve from the database plan review files within any of the selected Categories.

18. The system of claim 1, further comprising a module for executing steps to create an inspection order within a selected jurisdiction, wherein the steps comprise any of: providing a project number; identifying a jurisdiction; identifying address of the inspection order; identifying contact name associated with the inspection order; identifying status of the inspection order; identifying name of an inspector and status of the inspection order; requesting the system to retrieve from the database inspection orders within any of the selected categories.

19. The system of claim 18, further comprising a module for executing steps to search an inspector order within a selected jurisdiction, wherein the steps comprise any of: providing a project number; identifying a jurisdiction; identifying address of the inspection order; identifying contact name associated with the inspection order; requesting the system to retrieve from the database inspection orders within any of the selected categories.

20. The system of claim 18, further comprising a module for executing steps to search an inspector order within a selected jurisdiction, wherein the steps comprise any of: identifying an inspector's name and start date of inspection; identifying type of inspection to be performed at a property subject of land use modification; requesting the system to retrieve from the database names of inspectors inspection orders within any of the selected categories; reviewing a list of inspectors within the selected categories based on a physical location.

21. The system of claim 1, further comprising a module for executing steps to create an inspection report for an inspection project, wherein the steps comprise any of: identifying a project number; identifying a jurisdiction and inspection type; verifying address of the inspection project; identifying start and end date of an inspection request; requesting the system to retrieve from the database inspection orders within any of the selected categories.

22. The system of claim 21, further comprising a module for executing steps to search an inspection report within the system database, wherein the steps comprise any of: identifying an inspector name and start and end date of the inspection project; requesting the system to retrieve from the database inspection report within any of the selected categories.

23. The system of claim 1, further comprising a module for executing steps to assign an inspection project, wherein the steps comprise any of: identifying a start and end date of the inspection project; identifying type of the inspection project; identifying an inspector and status of the inspection project; reviewing a list of inspectors within the selected categories based on a physical location.

24. The system of claim 1, further comprising a module for executing steps to open a code enforcement project, wherein the steps comprise any of: identifying a code enforcement project number; identifying a start and end date of the project enforcement project; identifying jurisdiction and address of a property subject to code enforcement project; identifying contact name associated with the code enforcement project; requesting the system to retrieve from the database code enforcement files within any of the selected categories.

25. The system of claim 1, further comprising a module for executing steps to request address management, wherein the steps comprise any of: identifying an address subject of address request management; identifying a jurisdiction and assigned street address stored in the database; identifying a start and end date of the address request management; identifying customer name requesting address management; requesting the system to retrieve from the database code enforcement files within any of the selected categories.

26. The system of claim 1, further comprising a module for executing steps to create a customer address request, wherein the steps comprise any of: identifying a jurisdiction and type of request; identifying contact associated with the customer address request; describing a property subject of the customer address request address; uploading a map associated with the customer address request; creating an address for the identified property; storing the created address in the database.

27. The system of claim 26, further comprising a module for executing steps to open an address case, wherein the steps comprise any of: identifying a case number and address request; identifying a case type and status; identifying address point and case files associated with the address request; requesting from one or more systems additional information needed for identifying owner name and address; saving the created case in the system database.

28. The system of claim 27, further comprising a module for executing steps to generate a report based on the address request, wherein the steps comprise any of: identifying a street number and street name of the property; identifying designation of the street, name of city, postal zip code, community and ward.

29. The system of claim 28, further comprising a module for executing steps to search a street address of the property within the system database, wherein the steps comprise any of: identifying the street name, jurisdiction, community, postal zip code, ward and district; displaying on a computer screen results of the search

30. The system of claim 1, further comprising a module for executing steps to create a contact management file to be stored in the database, wherein the steps comprise any of: identifying name and address of the contact, and updating the database.

31. The system of claim 1, further comprising a module for executing steps to create a new street address to be stored in the database, wherein the steps comprise any of: identifying a street name and designation, identifying prefix and suffix type, identifying a jurisdiction and geographical orientation of the street, identifying a subdivision, where the new street is located, identifying an ordinance number authorizing creation of a new street and identifying a date of the ordinance, identifying street data and street point and providing street history, saving the created address in the system database; and new street address create a new street address for entering into database.

32. The system of claim 31, further comprising a module for executing steps to search an existing address within the system database, wherein the steps comprise any of: identifying the street name, retrieving records from the system database.

33. The system of claim 1, further comprising a module for executing steps to create a fee breakout report, wherein the steps comprise any of: identifying jurisdiction, start and end dates of the report, identifying a project type for which fee was collected, filtering search results by permit number, permit types, address, permit fee, total payments and balance to be paid.

34. The system of claim 1, further comprising a module for executing steps to create a fee overages and underages report, wherein the steps comprise any of: identifying start and end dates of the report, identifying jurisdiction, identifying project type and reviewing report results.

35. The system of claim 1, further comprising a module for executing steps to search fees collected for permit application of land use modification, plan review application and inspections, wherein the steps comprise any of: identifying start and end dates of the project, identifying jurisdiction, identifying project type and displaying permit fees collected according to permit reference number, amount of fees received for each permit application and a total amount of fees.

36. The system of claim 1, further comprising a module for executing steps of creating an invoice for projects associated with review of permit applications, plan reviews, inspections or address verification, wherein the steps comprise any of: identifying start and end dates of the project, identifying jurisdiction and project type, identifying customer details, and generating an invoice.

37. The system of claim 1, further comprising a module for executing steps of creating a report of fees collected within a specific date for projects associated with review of permit applications, plan reviews, inspections or address verification, wherein the steps comprise any of: identifying specific report date, identifying jurisdiction, and generating a report of collected fees to be stored in the database.

38. The system of claim 1, further comprising a module for executing steps of creating a report of fees collected for each specified land use activities for projects associated with review of permit applications, plan reviews, inspections or address verification, wherein the steps comprise any of: identifying a jurisdiction, verifying an address for the project, identifying the start and end dates of the report, creating a report of fees collected for each project and sorting search results according to project number and type of project.

39. The system of claim 1, further comprising a module for executing steps of creating a report of a number of each specified land use activities for projects associated with review of permit applications, plan reviews, inspections or address verification of properties within the jurisdiction, wherein the steps comprise any of: identifying a jurisdiction, identifying the project type, identifying the start and end dates of the report, creating the report based on the project type, assigned number of the project, owner of property, and address of the property.

40. The system of claim 1, further comprising a module for executing steps of creating a random audit report of projects associated with review of permit applications, plan reviews, inspections or address verification of properties within the jurisdiction, wherein the steps comprise any of: identifying a jurisdiction, identifying start and end dates of the random audit report, identifying project type, and generating the random audit report.

41. The system of claim 1, further comprising a module for executing steps of creating a weekly report of projects associated with review of permit applications, plan reviews, inspections or address verification of properties within the jurisdiction, wherein the steps comprise any of: identifying a jurisdiction, identifying start and end dates, of the weekly report, identifying type of project to be included in the report and creating the report showing the project number, address of the property, and type of the project.

42. The system of claim 1, further comprising a module for executing steps of creating an environmental management permit summary report of properties within the jurisdiction, wherein the steps comprise any of: identifying a jurisdiction, identifying start and end dates of the report results, identifying a type of permit application and creating the report while showing the environmental management permit type, number of permit, date of issuance, project number, property address, total fees collected, and an entity responsible for executing the project.

43. The system of claim 1, further comprising a module for executing steps of creating an environmental management permit summary report based on a type of a land use activity project of properties within the jurisdiction, wherein the steps comprise any of: identifying a jurisdiction, identifying start and end dates of the report results, and creating the environmental management permit summary report, while segregating report by a type of project, date of issuance of the environmental management permit, project number, address of the property, fees collected and an entity responsible for executing the project.

44. The system of claim 1, further comprising a module for executing steps of creating a building permit summary report according to selected districts within a jurisdiction, wherein the steps comprise any of: identifying the jurisdiction, identifying start and end dates of the report results and filtering search results based on the selected district.

45. The system of claim 1, further comprising a module for executing steps of creating a building permit summary report according to permit type for land use modification projects of properties within a jurisdiction, wherein the steps comprise any of: identifying the jurisdiction, filtering search based on start and end date of the search results, and displaying the search results, while showing a permit number assigned to the permit, date of issuance of the permit, name of applicant for the permit, fee collected and address of the property.

46. The system of claim 1, further comprising a module for executing steps of creating a report of fees due to a jurisdiction for issuance of a permit for land use modification projects of properties within a jurisdiction, wherein the steps comprise any of: identifying the jurisdiction, filtering search results based on start and end date, and displaying the search results, while showing a permit number assigned to the project, name of jurisdiction, type of permit, address of the property, dates of receipt of the permit, date of creation of the permit, and date of issuance of the permit.

47. The system of claim 1, further comprising a module for executing steps of creating a permit summary report according to permit category of permits for land use modification projects of properties within a jurisdiction, wherein the steps comprise any of: identifying the jurisdiction, filtering search results based on start and end date, and displaying the search results, while showing a permit number assigned to the project, date of issuance of the permit, address of the property and name of an entity associated with the project.

48. The system of claim 1, further comprising a module for executing steps of creating a report of customer permit requests for land use modification projects of properties within a jurisdiction, wherein the steps comprise any of: identifying a customer/applicant of the permit application, identifying a date when a permit application was created, and a means for approving or denying the customer permit request.

49. The system of claim 1, further comprising a module for executing steps of submitting an online application for permit of land use modification of a property within a jurisdiction, wherein the steps comprise any of: identifying a state and jurisdiction of the property, identifying a type of permit applied for, identifying address of the property and applicant's name, displaying a system-generated number assigned to the project and displaying date the application is created.

50. The system of claim 1, further comprising a module for executing steps of reviewing online applications for permit of land use modification of a property within a jurisdiction submitted by an identified applicant, wherein the steps comprise any of: identifying a state and jurisdiction of the property, identifying a type of permit applied for, identifying a project number and date of creation, identifying applicant's name and address, reviewing all applications submitted by the applicant, modifying the applicants upon demand and submitting an inspection request.

51. The system of claim 1, further comprising a module for executing steps of creating a customer account for online applications for permit of land use modification of a property within a jurisdiction, wherein the steps comprise any of: identifying a customer name and address, choosing a password for online applications, choosing a security questions and security answer, and submitting a new account request to the system.

52. The system of claim 1, further comprising a module for displaying online interactive application forms for projects of land use modifications of properties within a jurisdiction.

53. A computer implemented method for monitoring land use activities, comprising the steps of: identifying a jurisdiction to be monitored in connection with one or more projects associated with properties within the jurisdiction, the projects being any of: permit application for, and review of land use modification, plan review and approval for land use modification, and requests for, and inspection of land use modification for compliance with ordinances and regulations within the identified jurisdiction, wherein said jurisdiction comprises a specific geographic area; providing a computer executable logic module said logic module monitoring ongoing land use activities in connection with one or more jurisdiction in view of at least one land use restriction which limits how properties can be used or modified, and maintaining data in said logic module that are generated as a result of said monitoring by said logic module; creating a portal accessible by authorized jurisdiction users and customers; establishing electronic communication between the portal, a jurisdiction participant device and a customer participant device, and wherein said data further comprise data which vary between different geographic locations within said jurisdiction.

54. The method of claim 53, wherein said data related to the land use activities comprise any of: location of said land properties, name of a selected jurisdiction, permit application number, street address, description of land properties, mapping location, contact names and addresses associated with a specific permit application, type of land property associated with the specific permit application, type of land use modification, land property ownership, date of permit application, or category of permit application.

55. The method of claim 53, wherein said database further comprises a plurality of ordinances and regulations specific to selected jurisdictions, and wherein said ordinances and regulations pertain to land use activities within the selected jurisdictions.

56. The method of claim 53, wherein said data on permit application comprises any of: residential, commercial, new construction, renovation, electrical, plumbing, mechanical, fixtures, sewer, septic, fence, excavation, or pool.

57. The method of claim 53, wherein said plan review data comprises any of: category of plan review, residential, commercial, new, completed, in-progress, or contact name and address.

58. The method of claim 53, wherein said activity data is generated by authorized users within selected jurisdictions using applicant-submitted data and/or other activity data sets.

59. The method of claim 53, further comprising a step of providing an address verification module for executing steps to verify an address associated with a specific land use activity within one or more selected jurisdictions, wherein such steps comprise any of: checking against other data sources including mapping location, grid location, and municipal ordinances; requesting from one or more systems additional information needed for verification.

60. The method of claim 53, further comprising a step of providing a search module for executing steps to identify a project associated with a specific land use activity and property within one or more selected jurisdictions, wherein such steps comprise any of: identifying a physical address of the property, checking against other data sources including contact name and address associated with the property, name of subdivision, lot number within the subdivision, date of application for land use modification, project type including address verification, backflow prevention, code enforcement, hazard mitigation, occupational license, permit, variance, zoning, and citation of code enforcement; requesting from one or more systems additional information needed for identification.

61. The method of claim 53, further comprising a step of providing a search module for executing steps to create a project file to be stored in the database, wherein said steps comprise any of: identifying a jurisdiction from the selected jurisdictions; identifying a project type associated with land use modification; providing a description of the project; providing a physical address of a property subject of land use modification; providing contact name and address associated with the project; identifying files associated with the property within the database; providing type-of-permit information; providing land ownership and occupancy information; providing zoning information; providing flood zone information; providing data about physical attributes of the property including description, size, construction type, structure, and parking; providing information on the type of property subject of land use modification; requesting the system to generate a project number; associating the project number with the project file.

62. The method of claim 61, further comprising steps of: providing module for generating form letters to be sent to the contact name and address associated with the project; providing a module for generating certificates of occupancy and completion to be stored in the database and to be sent to the contact name and address; providing a module for executing steps to upload the project file into the system database, wherein said steps comprise any of: providing a file description; identifying a jurisdiction; identifying the project type; providing the project number and uploading the created file into the system database.

63. The method of claim 53, further comprising a step of providing a module for executing steps to create a contractor file to be stored in the database, wherein said steps comprise any of: providing a name and address of a contractor; providing a license number of the contractor; providing license expiration date; providing state contractor number, providing state identification number and a type of license the contractor holds, including HVAC, framing, painting, foundation drilling, plumbing, electrical, heating, air conditioning, or concrete work; providing bond and insurance information of the contractor; saving the created file in the database.

64. The method of claim 63, further comprising a step of providing a module for executing steps to search a contractor file within the database, wherein said steps comprise any of: providing a license number of the contractor; providing jurisdiction name, providing business name of the contractor and/or personal name of the contractor; providing a contractor type; and status of the contractor license; requesting from the system information needed for identification.

65. The method of claim 53, further comprising a step of providing a module for executing steps to search a list of projects within a selected jurisdiction, wherein the steps comprise any of: identifying a jurisdiction, identifying a project number; identifying requirements to be completed within the project, including building code review and/or construction drawings submittal; requesting from the system the list of projects including completed and non-completed requirements.

66. The method of claim 53, further comprising a step of providing a module for executing steps to search a list of plan review projects within a selected jurisdiction, wherein the steps comprise any of: identifying a project number; identifying a street address category of the plan review; identifying status of the plan review project; identifying a start and/or end date for the plan project; identifying name of contact associated with the plan review project; requesting the system to retrieve from the database a plan review file within any of the selected categories, including project number and category of the project; uploading revisions associated with the retrieved file; reviewing and generating notes for plan review file.

67. The method of claim 66, further comprising a step of providing a module for executing steps to search plan review projects within a selected jurisdiction, wherein the steps comprise any of: identifying the plan review project number; identifying address and contact name associated with the plan review project; identifying start and end date of the plan review project; requesting the system to retrieve from the database plan review files within any of the selected categories.

68. The method of claim 53, further comprising a step of providing a module for executing steps to create an inspection order within a selected jurisdiction, wherein the steps comprise any of: providing a project number; identifying a jurisdiction; identifying address of the inspection order; identifying contact name associated with the inspection order; identifying status of the inspection order; identifying name of an inspector and status of the inspection order; requesting the system to retrieve from the database inspection orders within any of the selected categories.

69. The method of claim 68, further comprising a step of providing a module for executing steps to search an inspector order within a selected jurisdiction, wherein the steps comprise any of: providing a project number; identifying a jurisdiction; identifying address of the inspection order; identifying contact name associated with the inspection order; requesting the system to retrieve from the database inspection orders within any of the selected categories.

70. The method of claim 68, further comprising a step of providing a module for executing steps to search an inspector order within a selected jurisdiction, wherein the steps comprise any of: identifying an inspector's name and start date of inspection; identifying type of inspection to be performed at a property subject of land use modification; requesting the system to retrieve from the database names of inspectors inspection orders within any of the selected categories; reviewing a list of inspectors within the selected categories based on a physical location.

71. The method of claim 53, further comprising a step of providing a module for executing steps to create an inspection report for an inspection project, wherein the steps comprise any of: identifying a project number; identifying a jurisdiction and inspection type; verifying address of the inspection project; identifying start and end date of an inspection request; requesting the system to retrieve from the database inspection orders within any of the selected categories.

72. The method of claim 71, further comprising a step of providing a module for executing steps to search an inspection report within the system database, wherein the steps comprise any of: identifying an inspector name and start and end date of the inspection project; requesting the system to retrieve from the database inspection report within any of the selected categories.

73. The method of claim 53, further comprising a step of providing a module for executing steps to assign an inspection project, wherein the steps comprise any of: identifying a start and end date of the inspection project; identifying type of the inspection project; identifying an inspector and status of the inspection project; reviewing a list of inspectors within the selected categories based on a physical location.

74. The method of claim 53, further comprising a step of providing a module for executing steps to open a code enforcement project, wherein the steps comprise any of: identifying a code enforcement project number; identifying a start and end date of the project enforcement project; identifying jurisdiction and address of a property subject to code enforcement project; identifying contact name associated with the code enforcement project; requesting the system to retrieve from the database code enforcement files within any of the selected categories.

75. The method of claim 53, further comprising a step of providing a module for executing steps to request address management, wherein the steps comprise any of: identifying an address subject of address request management; identifying a jurisdiction and assigned street address stored in the database; identifying a start and end date of the address request management; identifying customer name requesting address management; requesting the system to retrieve from the database code enforcement files within any of the selected categories.

76. The method of claim 53, further comprising a step of providing a module for executing steps to create a customer address request, wherein the steps comprise any of: identifying a jurisdiction and type of request; identifying contact associated with the customer address request; describing a property subject of the customer address request address; uploading a map associated with the customer address request; creating an address for the identified property; storing the created address in the database.

77. The method of claim 76, further comprising steps of:
providing a module for executing steps to open an address case, wherein the steps comprise any of: identifying a case number and address request; identifying a case type and status; identifying address point and case files associated with the address request; requesting from one or more systems additional information needed for identifying owner name and address; saving the created case in the system database;
providing a module for executing steps to generate a report based on the address request, wherein the steps comprise any of: identifying a street number and street name of the property; identifying designation of the street, name of city, postal zip code, community and ward;
providing a module for executing steps to search a street address of the property within the system database, wherein the steps comprise any of: identifying the street name, jurisdiction, community, postal zip code, ward and district; displaying on a computer screen results of the search

78. The method of claim 53, further comprising a step of providing a module for executing steps to create a contact management file to be stored in the database, wherein the steps comprise any of: identifying name and address of the contact, and updating the database.

79. The method of claim 53, further comprising a step of providing a module for executing steps to create a new street address to be stored in the database, wherein the steps comprise any of: identifying a street name and designation, identifying prefix and suffix type, identifying a jurisdiction and geographical orientation of the street, identifying a subdivision, where the new street is located, identifying an ordinance number authorizing creation of a new street and identifying a date of the ordinance, identifying street data and street point and providing street history, saving the created address in the system database; and new street address create a new street address for entering into database.

80. The method of claim 79, further comprising a step of providing a module for executing steps to search an existing address within the system database, wherein the steps comprise any of: identifying the street name, retrieving records from the system database.

81. The method of claim 53, further comprising a step of providing a module for executing steps to create a fee breakout report, wherein the steps comprise any of: identifying jurisdiction, start and end dates of the report, identifying a project type for which fee was collected, filtering search results by permit number, permit types, address, permit fee, total payments and balance to be paid.

82. The method of claim 53, further comprising a step of providing a module for executing steps to create a fee overages and underages report, wherein the steps comprise any of: identifying start and end dates of the report, identifying jurisdiction, identifying project type and reviewing report results.

83. The method of claim 53, further comprising a step of providing a module for executing steps to search fees collected for permit application of land use modification, plan review application and inspections, wherein the steps comprise any of: identifying start and end dates of the project, identifying jurisdiction, identifying project type and displaying permit fees collected according to permit reference number, amount of fees received for each permit application and a total amount of fees.

84. The method of claim 53, further comprising a step of providing a module for executing steps of creating an invoice for projects associated with review of permit applications, plan reviews, inspections or address verification, wherein the steps comprise any of: identifying start and end dates of the project, identifying jurisdiction and project type, identifying customer details, and generating an invoice.

85. The method of claim 53, further comprising a step of providing a module for executing steps of creating a report of fees collected within a specific date for projects associated with review of permit applications, plan reviews, inspections or address verification, wherein the steps comprise any of: identifying specific report date, identifying jurisdiction, and generating a report of collected fees to be stored in the database.

86. The method of claim 53, further comprising a step of providing a module for executing steps of creating a report of fees collected for each specified land use activities for projects associated with review of permit applications, plan reviews, inspections or address verification, wherein the steps comprise any of: identifying a jurisdiction, verifying an address for the project, identifying the start and end dates of the report, creating a report of fees collected for each project and sorting search results according to project number and type of project.

87. The method of claim 53, further comprising a step of providing a module for executing steps of creating a report of a number of each specified land use activities for projects associated with review of permit applications, plan reviews, inspections or address verification of properties within the jurisdiction, wherein the steps comprise any of: identifying a jurisdiction, identifying the project type, identifying the start and end dates of the report, creating the report based on the project type, assigned number of the project, owner of property, and address of the property.

88. The method of claim 53, further comprising a step of providing a module for executing steps of creating a random audit report of projects associated with review of permit applications, plan reviews, inspections or address verification of properties within the jurisdiction, wherein the steps comprise any of: identifying a jurisdiction, identifying start and end dates of the random audit report, identifying project type, and generating the random audit report.

89. The method of claim 53, further comprising a step of providing a module for executing steps of creating a weekly report of projects associated with review of permit applications, plan reviews, inspections or address verification of properties within the jurisdiction, wherein the steps comprise any of: identifying a jurisdiction, identifying start and end dates of the weekly report, identifying type of project to be included in the report and creating the report showing the project number, address of the property, and type of the project.

90. The method of claim 53, further comprising a step of providing a module for executing steps of creating an environmental management permit summary report of properties within the jurisdiction, wherein the steps comprise any of: identifying a jurisdiction, identifying start and end dates of the report results, identifying a type of permit application and creating the report while showing the environmental management permit type, number of permit, date of issuance, project number, property address, total fees collected, and an entity responsible for executing the project.

91. The method of claim 53, further comprising a step of providing a module for executing steps of creating an environmental management permit summary report based on a type of a land use activity project of properties within the jurisdiction, wherein the steps comprise any of: identifying a jurisdiction, identifying start and end dates of the report results, and creating the environmental management permit summary report, while segregating report by a type of project, date of issuance of the environmental management permit, project number, address of the property, fees collected and an entity responsible for executing the project.

92. The method of claim 53, further comprising a step of providing a module for executing steps of creating a building permit summary report according to selected districts within a jurisdiction, wherein the steps comprise any of: identifying the jurisdiction, identifying start and end dates of the report results and filtering search results based on the selected district.

93. The method of claim 53, further comprising a step of providing a module for executing steps of creating a building permit summary report according to permit type for land use modification projects of properties within a jurisdiction, wherein the steps comprise any of: identifying the jurisdiction, filtering search based on start and end date of the search results, and displaying the search results, while showing a permit number assigned to the permit, date of issuance of the permit, name of applicant for the permit, fee collected and address of the property.

94. The method of claim 53, further comprising a step of providing a module for executing steps of creating a report of fees due to a jurisdiction for issuance of a permit for land use modification projects of properties within a jurisdiction, wherein the steps comprise any of: identifying the jurisdiction, filtering search results based on start and end date, and displaying the search results, while showing a permit number assigned to the project, name of jurisdiction, type of permit, address of the property, dates of receipt of the permit, date of creation of the permit, and date of issuance of the permit.

95. The method of claim 53, further comprising a step of providing a module for executing steps of creating a permit summary report according to permit category of permits for land use modification projects of properties within a jurisdiction, wherein the steps comprise any of: identifying the jurisdiction, filtering search results based on start and end date, and displaying the search results, while showing a permit number assigned to the project, date of issuance of the permit, address of the property and name of an entity associated with the project.

96. The method of claim 53, further comprising a step of providing a module for executing steps of creating a report of customer permit requests for land use modification projects of properties within a jurisdiction, wherein the steps comprise any of: identifying a customer/applicant of the permit application, identifying a date when a permit application was created, and a means for approving or denying the customer permit request.

97. The method of claim 53, further comprising a step of providing a module for executing steps of submitting an online application for permit of land use modification of a property within a jurisdiction, wherein the steps comprise any of: identifying a state and jurisdiction of the property, identifying a type of permit applied for, identifying address of the property and applicant's name, displaying a system-generated number assigned to the project and displaying date the application is created.

98. The method of claim 53, further comprising a step of providing a module for executing steps of reviewing online applications for permit of land use modification of a property within a jurisdiction submitted by an identified applicant, wherein the steps comprise any of: identifying a state and jurisdiction of the property, identifying a type of permit applied for, identifying a project number and date of creation, identifying applicant's name and address, reviewing all applications submitted by the applicant, modifying the applicants upon demand and submitting an inspection request.

99. The method of claim 53, further comprising a step of providing a module for executing steps of creating a customer account for online applications for permit of land use modification of a property within a jurisdiction, wherein the steps comprise any of: identifying a customer name and address, choosing a password for online applications, choosing a security questions and security answer, and submitting a new account request to the system.

100. The method of claim 53, further comprising a step of providing a module for displaying online interactive application forms for projects of land use modifications of properties within a jurisdiction.

101. An object monitoring and management system for managing objects located within each one of a plurality of jurisdictions, the system comprising: a central database for storing information about each object, the central database enabling each jurisdiction to retrieve, write and modify the information about objects within the jurisdiction and create a jurisdiction database; an interface for permitting each jurisdiction to: create data access groups; register selected ones of a plurality of computer-operated units with each data access group; and associate each data access group with a selected subset of the information about objects located within the jurisdiction, such that each computer-operated unit that is registered with a given data access group is enabled to access only the respective subset of the information associated with that data access group; wherein each computer-operated unit: permits a user to at least create new records in the respective subset of the information for storing information about modifications to the objects in the jurisdiction database; and issues a respective object-modification identifier for each object modification, the new object identifier being assigned to the corresponding new record and is unique across the central database; and connection means for synchronizing the respective jurisdiction database with the central database.

102. The system of claim 101, wherein the central database is connected to an open network via a gateway that enables secure access to the central database by the jurisdiction and customers associated with each object.

103. The system of claim 102, wherein the connection means for synchronizing the subset of information with the central database comprises a link between the jurisdiction database and the open network for communication with the gateway.

104. The system of claim 103, wherein the link includes a connection to a computer that comprises conduit software for interacting with the jurisdiction database and the central database using the open network, to synchronize the jurisdiction database with the central database by exchanging information between the jurisdiction database and the central database.

105. The system of claim 102, wherein the open network is the Internet.

106. The system of claim 101, wherein each record of the central database comprises a respective timestamp that indicates when each record was last modified.

107. A computer implemented method for managing objects located within each one of a plurality of jurisdictions, the method comprising: providing a central database for storing information about each object, the central database enabling each jurisdiction to retrieve, write and modify the information about objects within a respective jurisdiction; providing a user interface that permits each jurisdiction to: create data access groups; register selected ones of a plurality of computer-operated units with each data access group; and associate each data access group with a selected subset of the information about objects located within the jurisdiction, such that each computer-operated unit that is registered with a given data access group is enabled to access only the respective subset of the information associated with that data access group; wherein each computer-operated unit: permits a user to at least create new records in the respective subset of the information for storing information about modifications to the objects in the jurisdiction database; and issues a respective object-modification identifier for each object modification, the new object identifier being assigned to the corresponding new record and is unique across the central database; and connection means for synchronizing the respective jurisdiction database with the central database.

108. The method of claim 107, wherein the central database is connected to an open network via a gateway that enables secure access to the central database by the jurisdiction and customers associated with each object.

109. The method of claim 108, wherein the connection means for synchronizing the subset of information with the central database comprises a link between the jurisdiction database and the open network for communication with the gateway.

110. The method claim 109, wherein the link includes a connection to a computer that comprises conduit software for interacting with the jurisdiction database and the central database using the open network, to synchronize the jurisdiction database with the central database by exchanging information between the jurisdiction database and the central database.

111. The method of claim 108, wherein the open network is the Internet.

112. The method of claim 107, wherein each record of the central database comprises a respective timestamp that indicates when each record was last modified.
